(19) United States
(12) Patent Application Publication
(10) Pub. No.: US 2021/0321610 A1
(43) Pub. Date: Oct. 21, 2021

(54) CONTROLLED RELEASE FORMULATIONS FOR AGROCHEMICALS

(71) Applicant: Bayer Aktiengesellschaft, Leverkusen (DE)

(72) Inventors: Andreas IDE, Langenfeld (DE); Smita PATEL, Leichlingen (DE); Holger EGGER, Koeln (DE); Daniel Gordon DUFF, Leverkusen (DE); Michael OSTENDORF, Leverkusen (DE); Roland DECKWER, Duesseldorf (DE); Duy LE, Cary, NC (US)

(21) Appl. No.: 17/265,496

(22) PCT Filed: Jul. 26, 2019
(86) PCT No.: PCT/EP2019/070210

§ 371 Date: Feb. 2, 2021

Related U.S. Application Data
(60) Provisional application No. 62/874,130, filed on Jul. 15, 2019.

(30) Foreign Application Priority Data
Jul. 27, 2018 (EP) 18186131.1

(51) Int. Cl. A01N 25/34; A01N 25/10; A01N 25/14; A01N 43/40; A01N 43/80; A01N 43/50

(52) U.S. Cl. CPC A01N 25/34; A01N 25/10; A01N 43/50; A01N 43/40; A01N 43/80; A01N 25/14

(57) ABSTRACT

The present invention relates to encapsulated active compounds (actives/active ingredients/AI) produced by different methods with minimized/eliminated negative effects on the plant/enhanced biological compatibility while efficacy against pests is maintained.

The present invention relates to encapsulated active compounds (actives/active ingredients/AI) produced by different methods with minimized/eliminated negative effects on the plant (phytotoxicity) resulting in enhanced biological compatibility while efficacy against pests is maintained.

### BACKGROUND OF THE INVENTION

Active ingredients can be formulated in various ways, wherein the properties of the actives and the process of formulation may raise problems with regard to processability, stability, usability and efficacy of the formulations as well as negative effects of the active ingredients itself on the plant.

Moreover, some formulations are advantageous over others for ecological and/or economical reasons.

As pointed out above, some useful activities show unwanted effects on plants when applied, like phytotoxicity leading to severe damage of the plant, leave necrosis (also denoted halo effect), late emergence (stunting), reduced yield, etc.

For some actives the severity of the side effect is almost independent of the applied concentration, i.e. despite of a significantly decreased active concentration the side effect is seen at unchanged severity. For example, a pronounced phytotoxicity (a.k.a. Halo) can be observed for Fluopyram treated soybean seeds in early stages of emergence, even if there is no more nematicidal or fungicidal effect at this decreased concentration. A similar negative side effect is seen for a number of dicotoleydons, including but not limited to soy beans, tomatos, cucumbers, peppers/capsicums when e.g. fluopyram is spray applied to soil. Further examples include phytotoxic effects of herbicides, including but not limited to e.g. diflufenican and/or isoxaflutole spray applied to soil for treatment of soy beans and corn.

To overcome these side-effects, it is generally known to control the release of the actives, thus lower concentrations might lead to less unwanted effects. However, alongside the controlled release of active, often a reduction or total loss of efficacy against the pest is being observed.

The challenge to manufacture a controlled release formulation is even more demanding for sprayable application forms, i.e. particle size restrictions apply, and very high active concentrations are required (in contrast to state of the art pharmaceutical controlled release applications). Alongside the physical and biological properties of such controlled release formulations economically aspects play an important role. The three herein described approaches differ significantly in their biological, physical and economical footprint. Economical refers to the number of involved process steps and consequently the cost of production. Table 0 shows general classification of the technologies and clearly indicates the fine balance between achievable product properties and economical considerations. Even though Approach A will not provide the best materials with respect to leaf damage reduction (phytotoxicity) it may be favoured because of industrialization. Approach A was found to provide reasonable and significant improvement with respect to phytotoxicity.

TABLE 0

| | Controlled | Controlled | Controlled |
|---|---|---|---|
| | release | release | release |
| | technology | technology | technology |
| | approach A | approach B | approach C |
| Easiness of industrial | ++ | + | + |
| manufacturing | | | |
| (process steps) | | | |
| Degree of controlled | + | ++ | ++ |
| release (leaf necrosis/ | | | |
| leaf damage reduction) | | | |
| Applicability to SC | ++ | ++ | 0 |
| formulation | | | |
| requirements, i.e. | | | |
| particle sizes <50 μm | | | |

The afore described boundaries require a controlled release par excellence, to manufacture agrochemical sprayable controlled release formulations, that achieve a significant reduction or elimination of negative side effects such as phytotoxicity while keeping the efficacy while fulfilling economical requirements.

Polymeric materials encapsulating compounds are described in WO2010039865A2. WO2007091494A1 describe pesticide preparations containing pesticide-containing resin with controlled release. WO200007443A1 discloses controlled release granules with an active containing hull on a solid carrier. U.S. Pat. No. 4,285,720A describes water immiscible organic substances which are encapsulated with polyurea.

A process for spray coat pharmaceutical particles is described in U.S. Pat. No. 5,632,102A, however, not disclosing coating of very fine particles.

Further EP1325775A1 and US2011228628A generally described a jet bed apparatus that allows coating of fine particles, although not for controlled release applications.

### DESCRIPTION OF THE INVENTION

Therefore, there is a need for improved formulations which are safe to handle, which retain the efficacy and consistency of use in a challenging agricultural environment, i.e. soil. In particular, significant reduction, or in some embodiments full elimination, of phytotoxicity side effects was surprisingly achieved on crops that are showing a very high sensitivity for phytotoxicity for respective pesticides.

In particular there is need for encapsulated active ingredients, e.g. for use said formulations according to the inventions.

The controlled release formulations disclosed herein will be applicable to Seeds, Soil, Leaf by Spray/Coating/Drench/Granular/Infurrow/Nursery box/Paddy field, and common field applications.

Further, the controlled release formulation may improve physical, chemical, biological compatibility (phytotoxicity) or stability or longevity for relevant actives or minimize/eliminate negative effects on the plant in afore mentioned applications.

In a preferred embodiment the reduction of phytotoxicity of the active ingredient is more than 50%, more preferred more than 80%, and most preferred more than 90% percent, while efficacy against pests is maintained. Maintained as used herein means the efficacy is at least at 50% or more of the not encapsulated reference.

The tested references refer to the same formulations comprising the same ingredients as the formulation according to the invention, except that the active is not encapsulated (in the reference).

These problems are solved by the embodiments for encapsulation of the present invention as described below as well as formulations containing said encapsulated actives and their use for agrochemical applications.

“Pests” as used in the present invention refers to insects, nematodes, fungi, bacteria, viruses and weeds.

“Actives” as used in the present invention include fungicides, herbicides, insecticides, nematicides, host defence inducers, biological agents and bactericides.

In one embodiment actives means fungicides.

In another embodiment actives means nematicides.

In another embodiment actives means herbicides.

In another embodiment actives means insecticides.

In another embodiment actives means host defence inducers.

In another embodiment actives means biological agents.

In another embodiment actives means bactericides.

“Seed Treatment” as used in the present invention means applying at least one active ingredient directly or in form of a coating directly on a seed before bringing said seed onto the field. For clarification sake, foliar applications, in furrow application, nursery box applications and soil applications are not seed treatment applications.

“Encapsulated active ingredients” as used herein refers to actives which are encapsulated according to methods A, B or C, respectively, described below.

The terms “active compounds”, “actives”, “active ingredients”, “agrochemical compounds” and “AIs” can be used herein interchangeably.

The term “CR” in the present invention, if not otherwise defined, means “controlled release”.

The following term-pairs can be used herein interchangeably: FLU/Fluopyram; DFF/Diflufenican; IFT/Isoxaflutole.

If not otherwise defined or with further parameter extended in the present invention, particle size is measured according to CIPAC (CIPAC=Collaborative International Pesticides Analytical Council; www.cipac.org) method MT 187 determined as D50 respectively D90=active ingredient particle size (laser diffraction 50%, respectively 90% of overall volume particles The mean particle size denotes the D50 value.

In the formulations of the present invention at least one active is encapsulated, while additional actives may be present non-encapsulated in the formulation.

The present invention further provides formulations, and application forms prepared from them, as crop protection agents and/or pesticidal agents, such as drench, drip and spray liquors, comprising at least one of the active compounds of the invention. The application forms may comprise further crop protection agents and/or pesticidal agents, and/or activity-enhancing adjuvants such as penetrants, and/or spreaders and/or retention promoters and/or humectants and/or fertilizers and or other commonly used adjuvants, for example.

Examples of typical formulations include emulsifiable concentrates (EC), emulsions in water (EW), suspension concentrates (SC, SE, FS, OD), water-dispersible granules (WG), granules (GR) and capsule concentrates (CS); these and other possible types of formulation are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations may comprise active agrochemical compounds other than one or more active compounds of the invention.

The formulations or application forms in question preferably comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect.

Examples of adjuvants are agents which promote the retention, spreading, attachment to the leaf surface, or penetration.

These formulations are produced in a known manner, for example by mixing the active compounds with auxiliaries such as, for example, extenders, solvents and/or solid carriers and/or further auxiliaries, such as, for example, surfactants. The formulations are prepared either in suitable plants or else before or during the application.

Suitable for use as auxiliaries are substances which are suitable for imparting to the formulation of the active compound or the application forms prepared from these formulations (such as, e.g., usable crop protection agents, such as spray liquors or seed dressings) particular properties such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

In principle it is possible to use all suitable solvents. Suitable solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

All suitable carriers may in principle be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used.

Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Suitable surfactants or dispersing aids, for example are all substances of this type which can customarily be employed in agrochemical agents such as non-ionic or anionic surfactants. Preferred non-ionic surfactants are polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, acetylene diol ethoxylates, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphate, sulphonated or sulphated and neutralized with bases.

Possible anionic surfactants are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde and salts of lignosulphonic acid, as well as polycarboxylic acids, sodium and potassium salts.

Preferred non-ionic surfactants are for example:

Tristyrylphenol ethoxylates comprising an average of 5-60 EO units;

castor oil ethoxylates comprising an average of 5-40 EO units (e.g. Berol® range, Emulsogen® EL range);

fatty alcohol ethoxylates comprising branched or linear alcohols with 8-18 carbon atoms and an average of 2-30 EO units;

block-copolymer of polyethylene oxide and polyhydroxystearic acid;

ethoxylated polymethacrylate graft copolymers;

polyvinylpyrrolidone based polymers;

polyvinylacetate based polymers;

ethoxylated diacetylene-diols (e.g. Surfynol® 4xx-range);

alkyl ether citrate surfactants (e.g. Adsee® CE range, Akzo Nobel);

alkyl polysaccharides/polyglycosides (e.g. Agnique® PG8107, PG8105, Atplus®438, AL-2559, AL-2575);

ethoxylated mono- or diesters of glycerine comprising fatty acids with 8-18 carbon atoms and an average of 10-40 EO units (e.g. Crovol® range);

block-copolymer of polyethylene oxide and polybutylene oxide.

organomodified polysiloxanes, e.g. BreakThru® OE444, BreakThru® S240, Silwet® L77, Silwet® 408, Silwet® 806.

Preferred anionic surfactants and polymers are for example:

Naphthalene sulphonate formaldehyde condensate, sodium salt;

sodium diisopropylnaphthalenesulphonate;

dioctylsulfosuccinate sodium salt;

tristyrylphenol ethoxylate sulfate and ammonium and potassium salts thereof;

tristyrylphenol ethoxylate phosphate and ammonium and potassium salts thereof;

ligninsulfonic acid, sodium salt;

styrene acrylic polymers;

polycarboxylic acids, sodium and potassium salts.

More preferred surfactants are ethoxylated polymethacrylate graft copolymers, polycarboxylic acids, sodium and potassium salts, tristyrylphenol ethoxylate sulfate and ammonium and potassium salts thereof, naphthalene sulphonate formaldehyde condensate, sodium salt and ethoxylated diacetylene-diols. In Table 1 tradenames for commonly known surfactants are shown:

TABLE 1
Exemplified trade names and CAS-No's of preferred surfactants

| Tradename | Company | General description | CAS- No. |
|---|---|---|---|
| Soprophor ® 4D384 | Solvay | tristyrylphenol ethoxylate (16EO) | 119432-41-6 |
| | | sulfate ammonium salt | |
| Synergen ® W10 | Clariant | dioctylsulfosuccinate sodium salt | 577-11-7 |
| | | (65-70%) | |
| Geropon ® T36 | Solvay | Sodium polycarboxylate | 37199-81-8 |
| Surfynol ® 440 | Air Products | 2.4.7.9-Tetramethyldec-5-yne- | 9014-85-1 |
| | | 4.7-diol, ethoxylated | |
| Morwet ® D425 | Akzo Nobel | Naphthalene sulphonate | 9008-63-3 |
| | | formaldehyde condensate Na salt | |
| Atlox ® 4913 | Croda | methyl methacrylate graft | 119724-54-8 |
| | | copolymer with polyethylene | |
| | | glycol | |
| Kuraray Poval ® 3-85 | Kuraray | Polyvinyl alcohol | 25213-24-5 |
| Berol ® 827 | Akzo Nobel | castor oil ethoxylate (25EO) | 26264-06-2 |
| Berol ® 829 | Akzo Nobel | castor oil ethoxylate (20EO) | 26264-06-2 |
| Emulsogen ® EL-400 | Clariant | castor oil ethoxylate (40EO) | 61791-12-6 |
| Silwet ® 408 | Momentive | Polyalkyleneoxide modified | 67674-67-3 |
| | | heptamethyltrisiloxane | |
| Silwet ® 806 | Momentive | Polyalkyleneoxide modified | 67674-67-3 |
| | | heptamethyltrisiloxane | |
| Silwet ® L77 | Momentive | Polyalkyleneoxide modified | 67674-67-3 |
| | | heptamethyltrisiloxane | |
| BreakThru ® OE 444 | Evonik | Siloxanes and Silicones, cetyl | 191044-49-2 |
| | Industries | Me, di-Me | |
| BreakThru ® S240 | Evonik | polyether modified trisiloxane | 134180-76-0 |
| | Industries | | |
| Genapol ® X080 | Clariant | alcohol ethoxylate (iso-C13- | 9043-30-5 |
| | | EO8) | |
| Agnique ® PG8107 | BASF | Oligomeric D-glucopyranose | 68515-73-1 |
| | | decyl octyl glycosides | |

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

In a preferred embodiment, the formulation with the encapsulated active comprises:
a) at least one encapsulated active ingredient,
b) a liquid phase,
c) optionally one or more emulsifier/dispersant,
d) optionally one or more carriers,
e) optionally one or more surfactants,
f) optionally further non-encapsulated active ingredients,
g) optionally further adjuvants selected from the group of extenders, stickers, penetrants, retention promoters, colourants and dyes, stabilizers, humectants and spreaders.

In a more preferred embodiment, the formulation with the encapsulated active comprises:
a) at least one encapsulated active ingredient,
b) a liquid phase,
c) optionally one or more emulsifier/dispersant,
d) optionally one or more carriers,
e) one or more surfactants, e.g. Geropon T36 and/or Morwet D 425,
f) optionally further non-encapsulated active ingredients,
g) optionally further adjuvants selected from the group of extenders, stickers, penetrants, retention promoters, colourants and dyes, stabilizers, humectants and spreaders.

In one embodiment the formulation consists of a) and b) which add up to 100%.

A suitable liquid phase for the formulation may be water (SC), Oils and/or organic solvents (OD).

Preferably the liquid phase is water.

Suitable cross linkers according to the present invention are typically those used to connect polymer chains. Crosslinkers therefore typically adjust the physico-chemical properties of polymer, for example reducing solubility, swellability, solvent and/or active permeability; increasing melting point and/or glass transition temperature. Any of the properties before may be changed through crosslinking to an extend that e.g. a soluble polymer becomes fully insoluble or thermoplastic polymer becomes thermosetting. Crosslinking is typically achieved chemically, either by complexation or kovalent linkage. Common examples for crosslinkers are aldehydes such as formaldehyde, glutaraldehyde, terephthalaldehyde, low molecular weight epoxides such as epichlorohydrin, activated esters such as NHS esters, imidoesters, maleimides, carbodiimide, other crosslinkers may include Pyridyldithiol, hydrazine, bi- or higher functional isocyanates or photo induced crosslinkers.

The capsules (encapsulated material) prepared according to methods A to C comprise between 1% and 99.9% by weight of active compound or, with particular preference, between 20% and 95% by weight of active compound, more preferably between 25% and 95% by weight of active compound, and most preferred between 50% and 95% by weight of active compound, based on the weight of the whole capsule (active+shell).

Before encapsulation the active compound has a particle size of preferably d₅₀<50 μm, more preferred d₅₀<20 μm, even more preferred d₅₀<10 μm, and most preferred d₅₀<5 μm.

Preferably, before encapsulation the active compound has a particle size of d₅₀>0.1 μm.

The particle size of the produced capsules is preferably between d₅₀=1-200 μm (micrometer), more preferred between d₅₀=1-50 μm (micrometer). For foliar applications the particle size is preferably between d₅₀=1-20 μm (micrometer).

The formulations preferably comprise between 0.1% and 70% by weight of active compound or, with particular preference, between 1% and 65% by weight of active compound, more preferably between 5% and 60% by weight of active compound, and most preferred between 5% and 50% by weight of active compound, based on the weight of the formulation.

The active compound content of the application forms for herbicides (including but not limited to Diflufenican & Isoxaflutole) prepared from the formulations may vary within wide ranges. The active compound concentration of the application forms may be situated typically between 0.00001% and 50% by weight of active compound, preferably between 0.001% and 5% by weight, based on the weight of the application form. Application takes place in a customary manner adapted to the application forms.

The active compound content of the application forms for nematicides/fungicides (including but not limited to Fluopyram) prepared from the formulations may vary within wide ranges. The active compound concentration of the application forms may be situated typically between 0.00001% and 50% by weight of active compound, preferably between 0.001% and 10% by weight, based on the weight of the application form. Application takes place in a customary manner adapted to the application forms.

In one embodiment the present invention is directed to encapsulated actives, the method of their production, formulations comprising the encapsulated actives, and a method and use for seed treatment with the encapsulated actives or the corresponding formulations.

In one embodiment the present invention is directed to encapsulated actives, the method of their production, formulations comprising the encapsulated actives, and a method and use for in furrow application with the encapsulated actives or the corresponding formulations.

In one embodiment the present invention is directed to encapsulated actives, the method of their production, formulations comprising the encapsulated actives, and a method and use for foliar application with the encapsulated actives or the corresponding formulations.

In one embodiment the present invention is directed to encapsulated actives, the method of their production, formulations comprising the encapsulated actives, and a method and use for soil application with the encapsulated actives or the corresponding formulations.

Suitable actives of the present invention are preferably those which are known to show unwanted effects when applied to plants.

Actives for the present invention are preferably selected from the group comprising herbicides, insecticides, nematicides, fungicides, host defence inducer, biological control agents.

Said actives may also be used as mixing partner for encapsulated actives. In one embodiment the same active is present encapsulated and in free form, which leads to fast initial uptake and continuous release and uptake of the same active for a prolonged time.

### Herbicides

Components which can be used as herbicide for encapsulation or in combination with the active compounds according to the invention, preferably in mixed formulations or in tank mix are, for example, known active compounds as they are described in, for example, Weed Research 26, 441-445 (1986), or “The Pesticide Manual”, 15th edition, The British Crop Protection Council and the Royal Soc. of Chemistry, 2006, and the literature cited therein, and which for example act as inhibitor of acetolactate synthase, acetyl-CoA-carboxylase, cellulose-synthase, enolpyruvylshikimat-3-phosphate-synthase, glutamin-synthetase, p-hydroxyphenylpyruvat-dioxygenase, phytoendesaturase, photosystem I, photosystem II and/or protoporphyrinogen-oxidase.

Examples of active compounds which may be mentioned as herbicides or plant growth regulators which are known from the literature are the following (compounds are either described by “common name” in accordance with the International Organization for Standardization (ISO) or by chemical name or by a customary code number), and always comprise all applicable forms such as acids, salts, ester, or modifications such as isomers, like stereoisomers and optical isomers. As an example at least one applicable from and/or modifications can be mentioned

Examples for herbicides are:

Acetochlor, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminocyclo-pyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat-dibromid, dithiopyr, diuron, DNOC, endothal, EPTC, esprocarb, ethalfluralin, ethametsulfuron, etha-metsulfuron-methyl, ethiozin, ethofumesate, ethoxyfen, ethoxyfen-ethyl, ethoxysulfuron, etobenzanid, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. O-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethyl, and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxo-imidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline, and the following compounds:

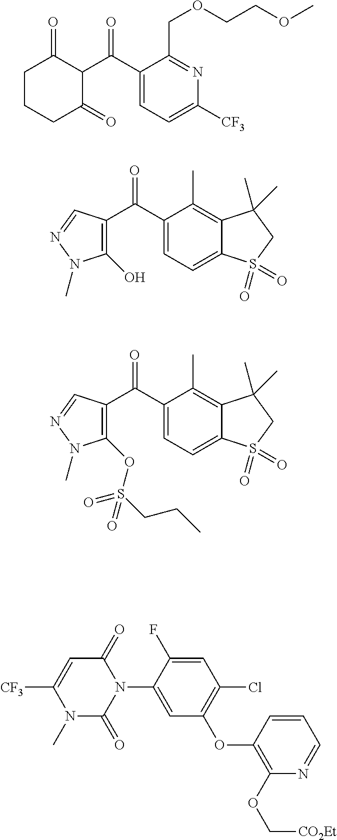 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl]

Examples for plant growth regulators are:

Acibenzolar, acibenzolar-S-methyl, 5-aminolevulinic acid, ancymidol, 6-benzylaminopurine, Brassinolid, catechine, chlormequat chloride, cloprop, cyclanilide, 3-(cycloprop-1-enyl) propionic acid, daminozide, dazomet, n-decanol, dikegulac, dikegulac-sodium, endothal, endothal-dipotassium, -disodium, and -mono(N,N-dimethylalkylammonium), ethephon, flumetralin, flurenol, flurenol-butyl, flurprimidol, forchlorfenuron, gibberellic acid, inabenfide, indol-3-acetic acid (IAA), 4-indol-3-ylbutyric acid, isoprothiolane, probenazole, jasmonic acid, maleic hydrazide, mepiquat chloride, 1-methylcyclopropene, methyl jasmonate, 2-(1-naphthyl)acetamide, 1-naphthylacetic acid, 2-naphthyloxyacetic acid, nitrophenolate-mixture, paclobutrazol, N-(2-phenylethyl)-beta-alanine, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

### Fungicides

Examples of active compounds which may be mentioned as fungicide which are known from the literature are the following (compounds are either described by “common name” in accordance with the International Organization for Standardization (ISO) or by chemical name or by a customary code number), and always comprise all applicable forms such as acids, salts, ester, or modifications such as isomers, like stereoisomers and optical isomers. As an example at least one applicable form and/or modifications can be mentioned.

The active ingredients specified herein by their Common Name are known and described, for example, in The Pesticide Manual (16th Ed. British Crop Protection Council) or can be searched in the internet (e.g. www.alanwood.net/pesticides).

Where a compound (A) or a compound (B) can be present in tautomeric form, such a compound is understood herein above and herein below also to include, where applicable, corresponding tautomeric forms, even when these are not specifically mentioned in each case.

All named mixing partners of the classes (1) to (15) can, if their functional groups enable this, optionally form salts with suitable bases or acids.

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) Pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl) 4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-y]methyl}-1H-1,2,4-triazol-5-yl thiocyanate. (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,233-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(23-dihydro-H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(rifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) Fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide. (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-H-pyrazol-5-amine, (4.015) 4-(2-bromo-4-fluorophenyl)-N-(2-chloro-6-fluorophenyl)-1,3-dimethyl-H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine. (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further compounds, for example (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium. (15.015) methyl isothiocyanate. (15.016) metrafenone. (15.017) mildiomycin. (15.018) natamycin, (15.019) nickel dimethykdithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone. (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one. (15.063) aminopyrifen.

### Safener:

Following groups of compounds are, for example, to be considered as safeners:
S1) compounds of the group of heterocyclic carboxylic acid derivatives:
S1^{a}) compounds of the type of dichlorophenylpyrazoline-3-carboxylic acid (S1^{a}), preferably compounds such as
   1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (Si-1) (“mefenpyr(-diethyl)”), and related compounds, as described in WO-A-91/07874;
S1^{b}) derivatives of dichlorophenylpyrazolecarboxylic acid (S1^{b}), preferably compounds such as
   ethyl 1-(2,4-dichlorophenyl)-5-methylpyrazole-3-carboxylate (S1-2),
   ethyl 1-(2,4-dichlorophenyl)-5-isopropylpyrazole-3-carboxylate (S1-3),
   ethyl 1-(2,4-dichlorophenyl)-5-(1,1-dimethylethyl)pyrazole-3-carboxylate (S1-4) and related compounds, as described in EP-A-333 131 and EP-A-269 806;
S1^{c}) derivatives of 1,5-diphenylpyrazole-3-carboxylic acid (S1^{c}), preferably compounds such as
   ethyl 1-(2,4-dichlorophenyl)-5-phenylpyrazole-3-carboxylate (S1-5),
   methyl 1-(2-chlorophenyl)-5-phenylpyrazole-3-carboxylate (S1-6) and related compounds, as described, for example, in EP-A-268554;
S1^{d}) compounds of the type of triazolecarboxylic acids (S1^{d}), preferably compounds such as
   fenchlorazole(-ethyl), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;
S1^{e}) compounds of the type of 5-benzyl- or 5-phenyl-2-isoxazoline-3-carboxylic acid or 5,5-diphenyl-2-isoxazoline-3-carboxylic acid (S1^{e}), preferably compounds such as ethyl 5-(2,4-dichlorobenzyl)-2-isoxazoline-3-carboxylate (Si-8) or ethyl 5-phenyl-2-isoxazoline-3-carboxylate (S1-9) and related compounds, as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in the patent application WO-A-95/07897.
S2) Compounds of the group of 8-quinolyloxy derivatives (S2):
S2^{a}) compounds of the type of 8-quinolinoxyacetic acid (S2^{a}), preferably
   1-methylhexyl (5-chloro-8-quinolinoxy)acetate (common name “cloquintocet-mexyl” (S2-1),
   1,3-dimethyl-but-1-yl (5-chloro-8-quinolinoxy)acetate (S2-2),
   4-allyloxybutyl (5-chloro-8-quinolinoxy)acetate (S2-3),
   1-allyloxyprop-2-yl (5-chloro-8-quinolinoxy)acetate (S2-4),
   ethyl (5-chloro-8-quinolinoxy)acetate (S2-5),
   methyl (5-chloro-8-quinolinoxy)acetate (S2-6),
   allyl (5-chloro-8-quinolinoxy)acetate (S2-7),
   2-(2-propylideneiminoxy)-1-ethyl (5-chloro-8-quinolinoxy)acetate (S2-8),
   2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), its hydrates and salts, for example its lithium, sodium, potassium, calcium, magnesium, aluminium, iron, ammonium, quaternary ammonium, sulphonium or phosphonium salts, as described in WO-A-2002/34048;
S2^{b}) compounds of the type of (5-chloro-8-quinolinoxy)malonic acid (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Active compounds of the type of dichloroacetamides (S3) which are frequently used as pre-emergence safeners (soil-acting safeners), such as, for example,
   “dichlormid” (N,N-diallyl-2,2-dichloroacetamide) (S3-1),
   “R-29148” (3-dichloroacetyl-2,2,5-trimethyl-1,3-oxazolidine) from Stauffer (S3-2),
   “R-28725” (3-dichloroacetyl-2,2-dimethyl-1,3-oxazolidine) from Stauffer (S3-3),
   “benoxacor” (4-dichloroacetyl-3,4-dihydro-3-methyl-2H-1,4-benzoxazine) (S3-4),
   “PPG-1292” (N-allyl-N-[(1,3-dioxolan-2-yl)methyl]dichloroacetamide) from PPG Industries (S3 5),
   “DKA-24” (N-allyl-N-[(allylaminocarbonyl)methyl]dichloroacetamide) from Sagro-Chem (S3-6),
   “AD-67” or “MON 4660” (3-dichloroacetyl-1-oxa-3-aza-spiro[4,5]decane) from Nitrokemia or Monsanto (S3-7),
   “TI-35” (1-dichloroacetylazepane) from TRI-Chemical RT (S3-8)
   “diclonon” (dicyclonon) or “BAS145138” or “LAB145138” (S3-9)
   ((RS)-1-dichloroacetyl-3,3,8a-trimethylperhydropyrrolo[1,2-a]pyrimidin-6-one) from BASF, furilazole” or “MON 13900” ((RS)-3-dichloroacetyl-5-(2-furyl)-2,2-dimethyloxazolidine) (S3-10), and also its (R)-isomer (53-11).
S4) Compounds of the class of acylsulphonamides (S4):
S4^{a}) N-acylsulphonamides of the formula (4′) and salts thereof, as described in WO-A-97/45016

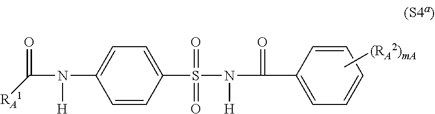

in which
R_{A}¹ is (C₁-C₆)-alkyl, (C₃-C₆)-cycloalkyl, where the 2 last-mentioned radicals are substituted by v_{A} substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
R_{A}² is halogen, (C₁-C₄)-alkyl, (C₁-C₄)-alkoxy, CF₃.
m_{A} is 1 or 2;
v_{D} is 0, 1, 2 or 3;
S4b) compounds of the type of 4-(benzoylsulphamoyl)benzamides of the formula (S4b) and salts thereof, as described in WO-A-99/16744,

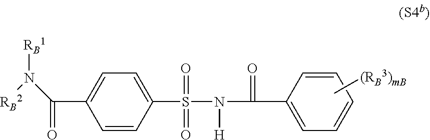

in which
R_{B}¹, R_{B}² independently of one another are hydrogen, (C₁-C₆)-alkyl, (C₃-C₆)-cycloalkyl, (C₃-C₆)-alkenyl, (C₃-C₆)-alkynyl,
R_{B}³ is halogen, (C₁-C₄)-alkyl, (C₁-C₄)-haloalkyl or (C₁-C₄)-alkoxy,
m_{B} is 1 or 2;
for example those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
   R_{B}¹=isopropyl, R_{B}²=hydrogen and (R_{B}³)=2-OMe (S4-5);
S4^{c}) compounds of the class of benzoylsulphamoylphenylureas of the formula (S4^{c}) as described in EP-A-365484,

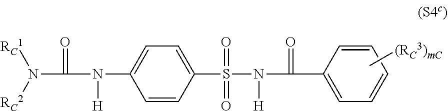

in which
R_{C}¹, R_{C}² independently of one another are hydrogen, (C₁-C₈)-alkyl, (C₃-C₈)-cycloalkyl, (C₃-C₆)-alkenyl, (C₃-C₆)-alkynyl,
R_{C}³ is halogen, (C₁-C₄)-alkyl, (C₁-C₄)-alkoxy, CF₃,
m_{C} is 1 or 2;
for example
1-[4-(N-2-methoxybenzoylsulphamoyl)phenyl]-3-methylurea (“metcamifen”, S4-6),
1-[4-(N-2-methoxybenzoylsulphamoyl)phenyl]-3,3-dimethylurea,
1-[4-(N-4,5-dimethylbenzoylsulphamoyl)phenyl]-3-methylurea;
S4^{d}) compounds of the type of N-phenylsulphonylterephthalamides of the formula (S4^{d}) and salts thereof, which are known, for example, from CN 101838227,

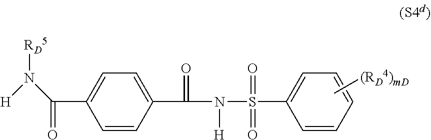

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active compounds from the class of hydroxyaromatics and aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active compounds from the class of 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulphonylaminoethyl)-3-(2-thienyl)-1,2-dihydroquinoxalin-2-one, as described in WO-A-2005/112630.
S7) Compounds from the class of diphenylmethoxyacetic acid derivatives (S7), for example methyl diphenylmethoxyacetate (CAS-Reg.Nr. 41858-19-9) (S7-1), ethyl diphenylmethoxyacetate, or diphenylmethoxyacetic acid, as described in WO-A-98/38856.
58) Compounds of the formula (S8), as described in WO-A-98/27049,
   where the symbols and indices have the following meanings:

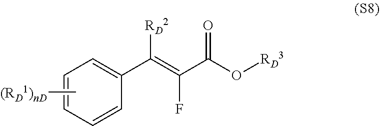

R_{D}¹ is halogen, (C₁-C₄)-alkyl, (C₁-C₄)-haloalkyl, (C₁-C₄)-alkoxy, (C₁-C₄)-haloalkoxy,
R_{D}² is hydrogen or (C₁-C₄)-alkyl,
R_{D}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
n_{D} is an integer from 0 to 2.
S9) Active compounds from the class of 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999/000020.
S10) Compounds of the formula (S10^{a}) or (S10^{b}) as described in WO-A-2007/023719 and WO-A-2007/023764
   in which

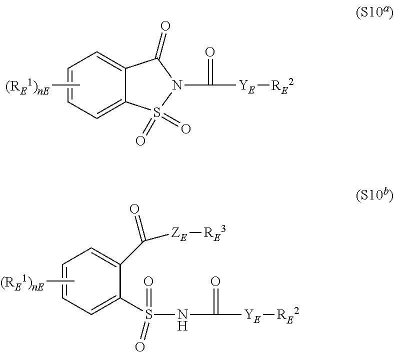

R_{E}¹ is halogen, (C₁-C₄)-alkyl, methoxy, nitro, cyano, CF₃, OCF₃
Y_{E}, Z_{E} independently of one another are O or S,
n_{E} is an integer from 0 to 4,
R_{E}² is (C₁-C₁₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
S11) Active compounds of the type of oxyimino compounds (S11), which are known as seed dressings, such as, for example,
   “oxabetrinil” ((Z)-1,3-dioxolan-2-ylmethoxyimino(phenyl)acetonitrile) (S11-1), which is known as seed dressing safener for millet against metolachlor damage,
   “fluxofenim” (1-(4-chlorophenyl)-2,2,2-trifluoro-1-ethanone O-(1,3-dioxolan-2-ylmethyl)oxime) (S11-2), which is known as seed dressing safener for millet against metolachlor damage, and
   “cyometrinil” or “CGA-43089” ((Z)-cyanomethoxyimino(phenyl)acetonitrile) (S11-3), which is known as seed dressing safener for millet against metolachlor damage.
S12) Active compounds from the class of isothiochromanones (S12), such as, for example, methyl [(3-oxo-1H-2-benzothiopyran-4(3H)-ylidene)methoxy]acetate (CAS Reg. No.: 205121-04-6) (S12-1) and related compounds from WO-A-1998/13361.
S13) One or more compounds from group (S13):
   “naphthalic anhydrid” (1,8-naphthalenedicarboxylic anhydride) (S13-1), which is known as seed dressing safener for corn against thiocarbamate herbicide damage,
   “fenclorim” (4,6-dichloro-2-phenylpyrimidine) (S13-2), which is known as safener for pretilachlor in sown rice,
   “flurazole” (benzyl 2-chloro-4-trifluoromethyl-1,3-thiazole-5-carboxylate) (S13-3), which is known as seed dressing safener for millet against alachlor and metolachlor damage,
   “CL 304415” (CAS Reg. No.: 31541-57-8)
   (4-carboxy-3,4-dihydro-2H-1-benzopyran-4-acetic acid) (S13-4) from American Cyanamid, which is known as safener for corn against imidazolinone damage,
   “MG 191” (CAS Reg. No.: 96420-72-3) (2-dichloromethyl-2-methyl-1,3-dioxolane) (S13-5) from Nitrokemia, which is known as safener for corn,
   “MG 838” (CAS Reg. No.: 133993-74-5)
   (2-propenyl 1-oxa-4-azaspiro[4.5]decane-4-carbodithioate) (S13-6) from Nitrokemia,
   “disulphoton” (O,O-diethyl S-2-ethylthioethyl phosphorodithioate) (S13-7),
   “dietholate” (O,O-diethyl O-phenyl phosphorothioate) (S13-8),
   “mephenate” (4-chlorophenyl methylcarbamate) (S13-9).
S14) Active compounds which, besides a herbicidal effect against harmful plants, also have a safener effect on crop plants such as rice, such as, for example, “dimepiperate” or “MY 93” (S-1-methyl-1-phenylethyl piperidine-1-carbothioate), which is known as safener for rice against molinate herbicide damage,
   “daimuron” or “SK 23” (1-(1-methyl-1-phenylethyl)-3-p-tolylurea), which is known as safener for rice against imazosulphuron herbicide damage,
   “cumyluron”=“JC 940” (3-(2-chlorophenylmethyl)-1-(1-methyl-1-phenylethyl)urea, see JP-A-60087254), which is known as safener for rice against some herbicide damage,
   “methoxyphenone” or “NK 049” (3,3′-dimethyl-4-methoxybenzophenone), which is known as safener for rice against some herbicide damage,
   “CSB” (1-bromo-4-(chloromethylsulphonyl)benzene) from Kumiai (CAS Reg. No. 54091-06-4), which is known as safener against some herbicide damage in rice.
S15) Compounds of the formula (S15) or its tautomers,

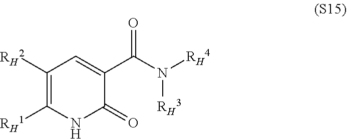

as described in WO-A-2008/131861 and WO-A-2008/131860,
in which
R_{H}¹ is (C₁-C₆)-haloalkyl,
R_{H}² is hydrogen or halogen,
R_{H}³, R_{H}⁴ independently of one another are hydrogen, (C₁-C₁₆)-alkyl, (C₂-C₁₆)-alkenyl or (C₂-C₁₆)-alkynyl,
   where each of the 3 last-mentioned radicals is unsubstituted or substituted by one or more radicals from the group consisting of halogen, hydroxy, cyano, (C₁-C₄)-alkoxy, (C₁-C₄)-haloalkoxy, (C₁-C₄)-alkylthio, (C₁-C₄)-alkylamino, di-[(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl;
or (C₃-C₆)-cycloalkyl, (C₄-C₆)-cycloalkenyl, (C₃-C₆)-cycloalkyl which is at one site of the ring condensed with a 4 to 6-membered saturated or unsaturated carbocyclic ring, or (C₄-C₆)-cycloalkenyl which is at one site of the ring condensed with a 4 to 6-membered saturated or unsaturated carbocyclic ring,
   where each of the 4 last-mentioned radicals is unsubstituted or substituted by one or more radicals from the group consisting of halogen, hydroxy, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di-(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl; or
R_{H}³ is (C₁-C₄)-alkoxy, (C₂-C₄)-alkenyloxy, (C₂-C₆)-alkynyloxy or (C₂-C₄)-haloalkoxy, and
R_{H}⁴ is hydrogen or (C₁-C₄)-alkyl, or
R_{H}³ and R_{H}⁴ together with the directly bound N-atom are a 4 to 8-membered heterocyclic ring, which can contain further hetero ring atoms besides the N-atom, preferably up to two further hetero ring atoms from the group consisting of N, O and S, and which is unsubstituted or substituted by one or more radicals from the group consisting of halogen, cyano, nitro, (C₁-C₄)-alkyl, (C₁-C₄)-haloalkyl, (C₁-C₄)-alkoxy, (C₁-C₄)-haloalkoxy, and (C₁-C₄)-alkylthio.
S16) Active compounds which are primarily used as herbicides, but also have safener effect on crop plants, for example
   (2,4-dichlorophenoxy)acetic acid (2,4-D),
   (4-chlorophenoxy)acetic acid,
   (R,S)-2-(4-chloro-o-tolyloxy)propionic acid (mecoprop),
   4-(2,4-dichlorophenoxy)butyric acid (2,4-DB),
   (4-chloro-o-tolyloxy)acetic acid (MCPA),
   4-(4-chloro-o-tolyloxy)butyric acid,
   4-(4-chlorophenoxy)butyric acid,
   3,6-dichloro-2-methoxybenzoic acid (dicamba),
   1-(ethoxycarbonyl)ethyl 3,6-dichloro-2-methoxybenzoate (lactidichlor-ethyl).

### Biological Control Agents:

As used herein, “biological control” is defined as control of a pathogen and/or insect and/or an acarid and/or a nematode by the use of a second organism. Known mechanisms of biological control include enteric bacteria that control root rot by out-competing fungi for space on the surface of the root. Bacterial toxins, such as antibiotics, have been used to control pathogens. The toxin can be isolated and applied directly to the plant or the bacterial species may be administered so it produces the toxin in situ.

Biological control agents include in particular bacteria, fungi or yeasts, protozoa, viruses, entomopathogenic nematodes, inoculants and botanicals and/or mutants of them having all identifying characteristics of the respective strain, and/or a metabolite produced by the respective strain that exhibits activity against insects, mites, nematodes and/or phytopathogens.

According to the invention, biological control agents which are summarized under the term “bacteria” include spore-forming, root-colonizing bacteria, or bacteria and their metabolites useful as biological insecticides, -nematicides, miticides, or -fungicide or soil amendments improving plant health and growth.

Biological control agents according to the invention, in combination with good plant tolerance and favourable toxicity to warm-blooded animals and being tolerated well by the environment, are suitable for protecting plants and plant organs, for increasing harvest yields, for improving the quality of the harvested material and for controlling animal pests, in particular insects, arachnids, belminths, nematodes and molluscs, which are encountered in agriculture, in horticulture, in animal husbandry, in forests, in gardens and leisure facilities, in the protection of stored products and of materials, and in the hygiene sector. They can be preferably employed as plant protection agents. They are active against normally sensitive and resistant species and against all or some stages of development. Biological control agents include in particular bacteria, fungi or yeasts, protozoa, viruses, entomopathogenic nematodes, products produced by microorganisms including proteins or secondary metabolites and botanical, especially botanical extracts.

According to the invention, the biological control agent may be employed or used in any physiologic state such as active or dormant.

### Insecticides/Acaricides/Nematicides:

The active ingredients specified herein by their “common name” are known and described, for example, in the Pesticide Manual (“The Pesticide Manual”, 14th Ed., British Crop Protection Council 2006) or can be searched in the internet (e.g. http://www.alanwood.net/pesticides).

(1) Acetylcholinesterase (AChE) inhibitors, for example carbamates, e.g. Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC and Xylylcarb or organophosphates, e.g. Acephate, Azamethiphos, Azinphos-ethyl, Azinphos-methyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl)salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon and Vamidothion.

(2) GABA-gated chloride channel antagonists, for example cyclodiene organochlorines, e.g. Chlordane and Endosulfan, or phenylpyrazoles (fiproles), e.g. Ethiprole and Fipronil.

(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.

(4) Nicotinic acetylcholine receptor (nAChR) agonists, for example neonicotinoids, e.g. Acetamiprid, Clothianidin, Dinotefuran, Imidacloprid, Nitenpyram, Thiacloprid and Thiamethoxam or Nicotine or Sulfoxaflor or Flupyridafurone.

(5) Nicotinic acetylcholine receptor (nAChR) allosteric activators, for example spinosyns, e.g. Spinetoram and Spinosad.

(6) Chloride channel activators, for example avermectins/milbemycins, e.g. Abamectin, Emamectin benzoate, Lepimectin and Milbemectin.

(7) Juvenile hormone mimics, for example juvenile hormone analogues, e.g. Hydroprene, Kinoprene and Methoprene or Fenoxycarb or Pyriproxyfen.

(8) Miscellaneous non-specific (multi-site) inhibitors, for example alkyl halides, e.g. Methyl bromide and other alkyl halides; or Chloropicrin or Sulfuryl fluoride or Borax or Tartar emetic.

(9) Selective homopteran feeding blockers, e.g. Pymetrozine or Flonicamid.

(10) Mite growth inhibitors, e.g. Clofentezine, Hexythiazox and Diflovidazin or Etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis and BT crop proteins: Cry1Ab, Cry1Ac, Cry1Fa, Cry2Ab, mCry3A, Cry3Ab, Cry3Bb, Cry34/35Ab1.

(12) Inhibitors of mitochondrial ATP synthase, for example Diafenthiuron or organotin miticides, e.g. Azocyclotin, Cyhexatin and Fenbutatin oxide or Propargite or Tetradifon.

(13) Uncouplers of oxidative phoshorylation via disruption of the proton gradient, for example Chlorfenapyr, DNOC and Sulfluramid.

(14) Nicotinic acetylcholine receptor (nAChR) channel blockers, for example Bensultap, Cartap hydrochloride, Thiocyclam and Thiosultap-sodium.

(15) Inhibitors of chitin biosynthesis, type 0, for example Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.

(16) Inhibitors of chitin biosynthesis, type 1, for example Buprofezin.

(17) Moulting disruptors, for example Cyromazine.

(18) Ecdysone receptor agonists, for example Chromafenozide, Halofenozide, Methoxyfenozide and Tebufenozide.

(19) Octopamine receptor agonists, for example Amitraz.

(20) Mitochondrial complex III electron transport inhibitors, for example Hydramethylnon or Acequinocyl or Fluacrypyrim.

(21) Mitochondrial complex I electron transport inhibitors, for example METI acaricides, e.g. Fenazaquin, Fenpyroximate, Pyrimidifen, Pyridaben, Tebufenpyrad and Tolfenpyrad or Rotenone (Derris).

(22) Voltage-dependent sodium channel blockers, e.g. Indoxacarb or Metaflumizone.

(23) Inhibitors of acetyl CoA carboxylase, for example tetronic and tetramic acid derivatives, e.g. Spirobudiclofen, Spirodiclofen, Spiromesifen and Spirotetramat.

(24) Mitochondrial complex IV electron transport inhibitors, for example phosphines, e.g. Aluminium phosphide, Calcium phosphide, Phosphine and Zinc phosphide or Cyanide.

(25) Mitochondrial complex II electron transport inhibitors, for example Cyenopyrafen and Cyflumetofen.

(28) Ryanodine receptor modulators, for example diamides, e.g. Chlorantraniliprole, Cyantraniliprole, Flubendiamide and Tetrachloroantraniliprole.

Further active ingredients with unknown or uncertain mode of action, for example Afidopyropen, Afoxolaner, Azadirachtin, Benclothiaz, Benzoximate, Bifenazate, Broflanilide, Bromopropylate, Chinomethionat, Cryolite, Cyclaniliprole, Cycloxaprid, Cyhalodiamide Dicloromezotiaz, Dicofol, Diflovidazin, Flometoquin, Fluazaindolizine, Fluensulfone, Flufenerim, Flufenoxystrobin, Flufiprole, Fluhexafon, Fluopyram, Fluralaner, Fluxametamide, Fufenozide, Guadipyr, Heptafluthrin, Imidaclothiz, Iprodione, Lotilaner, Meperfluthrin, Paichongding, Pyflubumide, Pyridalyl, Pyrifluquinazon, Pyriminostrobin, Sarolaner, Tetramethylfluthrin, Tetraniliprole, Tetrachlorantraniliprole, Tioxazafen, Thiofluoximate, Triflumezopyrim and Iodomethane; furthermore products based on Bacillus firmus (including but not limited to strain CNCM I-1582, such as, for example, VOTiVO™, BioNem) or one of the following known active compounds: 1-{2-fluoro-4-methyl-5-[(2,2,2-trifluoroethyl)sulfinyl]phenyl}-3-(trifluoromethyl)-1H-1,2,4-triazol-5-amine (known from WO2006/043635), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), 4-(but-2-yn-1-yloxy)-6-(3-chlorophenyl)pyrimidine (known from WO2003/076415), PF1364 (CAS-Reg.No. 1204776-60-2), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), 8-chloro-N-[(2-chloro-5-methoxyphenyl)sulfonyl]-6-(trifluoromethyl)imidazo[1,2-a]pyridine-2-carboxamide (known from WO2009/080250), N-[(2E)-1-[(6-chloropyridin-3-yl)methyl]pyridin-2(1H)-ylidene]-2,2,2-trifluoroacetamide (known from WO2012/029672), 1-[(2-chloro-1,3-thiazol-5-yl)methyl]-4-oxo-3-phenyl-4H-pyrido[1,2-a]pyrimidin-1-ium-2-olate (known from WO2009/099929), 1-[(6-chloropyridin-3-yl)methyl]-4-oxo-3-phenyl-4H-pyrido[1,2-a]pyrimidin-1-ium-2-olate (known from WO2009/099929), 4-(3-{2,6-dichloro-4-[(3,3-dichloroprop-2-en-1-yl)oxy]phenoxy}propoxy)-2-methoxy-6-(trifluoromethyl)pyrimidine (known from CN101337940), N-[2-(tert-butylcarbamoyl)-4-chloro-6-methylphenyl]-1-(3-chloropyridin-2-yl)-3-(fluoromethoxy)-1H-pyrazole-5-carboxamide (known from WO2008/134969), butyl [2-(2,4-dichlorophenyl)-3-oxo-4-oxaspiro[4.5]dec-1-en-1-yl] carbonate (known from CN 102060818), 3E)-3-[1-[(6-chloro-3-pyridyl)methyl]-2-pyridylidene]-1,1,1-trifluoro-propan-2-one (known from WO2013/144213), N-(methylsulfonyl)-6-[2-(pyridin-3-yl)-1,3-thiazol-5-yl]pyridine-2-carboxamide (known from WO2012/000896), N-[3-(benzylcarbamoyl)-4-chlorophenyl]-1-methyl-3-(pentafluoroethyl)-4-(trifluoromethyl)-1H-pyrazole-5-carboxamide (known from WO2010/051926), 5-bromo-4-chloro-N-[4-chloro-2-methyl-6-(methylcarbamoyl)phenyl]-2-(3-chloro-2-pyridyl)pyrazole-3-carboxamido (known from CN103232431), Tioxazafen, 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013050317 A1), N-[3-chloro-1-(3-pyridinyl)-1H-pyrazol-4-yl]-N-ethyl-3-[(3,3,3-trifluoropropyl) sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013162715 A2, WO 2013162716 A2, US 20140213448 A1), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A); N-[4-chloro-2-[[(1,1-dimethylethyl) amino]carbonyl]-6-methylphenyl]-1-(3-chloro-2-pyridinyl)-3-(fluoromethoxy)-1H-Pyrazole-5-carboxamide (known from WO 2012034403 A1), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011085575 A1), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A); 3-(2,2-dichloroethenyl)-2,2-dimethyl-4-(1H-benzimidazol-2-yl)phenyl-cyclopropanecarboxylic acid ester (known from CN 103524422 A); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A).

Preferred active compounds are selected from the group comprising SDH-Inhibitors, nAChR-Agonists (including neonicotinoides), chlorotica including PDS inhibitors (HRAC F1) and HPPD inhibitors (HRAC F2) and thiadiazole carboxamides/host defence inducers.

More preferred active compounds for encapsulation according to the invention are selected from the group comprising Fluopyram, Flupyradifurone, Diflufenican, Isoxaflutole, Imidacloprid and Isotianil.

Most preferred active compounds Fluopyram, Diflufenican, Isoxaflutole.

Preferably the active is solid at room temperature, wherein room temperature in the instant application is 20° C. if not otherwise defined.

Moreover, the active is insoluble in water, wherein insoluble means a solubility of less than 1 g/l at room temperature and pH 7.

Preferably the encapsulated actives of the instant application or the corresponding formulations may be used in Dicotyledons, e.g. Soy (e.g. FLU, DFF) tomato (e.g. FLU), cucumber (e.g. FLU), and pepper or Monocotyledons, like corn (e.g. IFM), or cereals.

The encapsulated actives according to the present invention can be produced by three alternative processes, which are described in the following:

### Methods

As far as not otherwise indicated in the present invention % refers to weight percent (wt. %).

### Planting and Growth

For Seed treatment all soybean seeds were allowed to dry for 24 hr. prior to planting and were run alongside an untreated control (UTC) and a FLU FS 600 (48 w/w %, 0.075 mg/seed) treated sample for comparison.

Greenhouse evaluations were conducted using a pasteurized sandy loam soil consisting of less than 1% soil organic matter and a minimum of 20 reps for each treatment. Three planting options were utilized based on greenhouse space and experiment size 1) 60 cell trays 2) 30 cell trays and 6 in. stand alone pots. Prior to planting 6 in. pots were wet with 150 mL of water per pot, while 30 and 60 cell trays were irrigated for 10 s with an overhead water source. Subsequently, a 2 cm hole was created and 1 seed was planted per hole and covered with soil. Plants were grown for approximately 21 d in a temperature and day length regulated greenhouse. Water was uniformly supplied at regular intervals throughout the growth period. All trials demonstrated a germination rate of 90% or greater.

Cotyledons were harvested when the unifoliate leaves reached full development and analyzed for the halo effect. Specifically, cotyledons were removed and analyzed when unifoliate leaves are fully emerged for all samples and the first trifoliate leaves are present but not fully developed. The top of each cotyledon was scanned and analyzed using WinFolia software which measured total leaf area, healthy leaf area, and halo area. Differentiation between healthy and halo cotyledon area was determined by using color screening analysis, where darker regions signified halo area and green regions signified healthy leaf tissue. For seeds treated with formulations obtained according to process A to C a visual halo rating system was also employed which consisted of a rating system from 0 to 4. The criteria for each rating are outlined in

FIG. 1: Unifoliate leaves were analyzed for size using WinFolia software after the first trifoliate leaves were fully emerged.

Plant heights were typically measured at approximately 7 DAP (days after planting), which is when unifoliate leaves first emerge and begin to develop and at 14 DAP or when the first trifoliate has completely emerged.

Canopy analysis was performed at 7-10 days after planting (DAP) to determine the impact of the treatment on stunting. Images were taken and analyzed using the app Canopeo which quantifies the canopy cover of green vegetation using images taken with a mobile device. Images were taken at the same distance from the samples and under similar light conditions.

Root Lesion Nematode (RLN) Bioassay was conducted 7 DAP soybean seeds were inoculated with 1000-2000 RLN juveniles using a standard inoculation methodology. In brief, the soybean pots were wet 5 min prior to inoculation, then a 2 cm deep hole was created next to the stem of the soybean plant. Subsequently, a pipette was used to dispense 0.5-1.0 mL of inoculum into the hole. Next, the roots were removed from soil, cleaned of excess sand and soil, and briefly submerged in water. The roots where then blotted with a paper towel and cut into 1 to 2 cm pieces that were spread onto a baeman funnel (˜2 g fresh weight/funnel). The funnels were covered with foil and allowed to sit for 3 d. The funnels were then drained and 30 mL of liquid was retained and the RLN count was determined from this sample.

Sudden Death Syndrome (SDS) Bioassay was conducted by preparing an inoculum by placing 800 g of wheat into beaker and covering with potato dextrose broth. The beaker was then autoclaved for 30 mins on 2 consecutive days. After 24-28 h post autoclave, 1 plate of Fusarium virguliforme was added to each beaker and grown at room temperature. After 14 d the jars were grown out and desiccated.

Next a cone was stacked with 100 cc of soil, followed by WA plate of Fusarium virguliforme inoculum. Two soybean seeds were placed on top and the cone was filled with 40 cc of soil. The seeds were grown under wet conditions and evaluated for SDS symptoms at the first trifoliate using a 0-6 scale, where 0 represents no symptoms and 6 represents a wilted or dead plant.

### Biology Tests in Herbicide Soil Spray Applications for Controlled Release Formulations (General Procedure)

Samples were supplied as aqueous suspensions and were applied at 50,100, 200 g active per hectare. Briefly, seeds of grasses, weeds and agricultural crops were seeded in pots with 8 cm diameter in natural soil (slit-rich, non-sterile). Seeds were covered with 0.5 cm of soil and cultivated in a glasshouse (12-16 h light, temperature day 20-22° C., night 15-18° C.). At the BBCH 00 state of growth of the seeds/plants the inventive formulation was applied using a water volume of 300 L/ha. After herbicide treatment all plants were cultivated further in the glasshouse as described above. Daily irrigation was set to 1.0-1.5 liter per square meter. Efficacy of the treatment was visually assessed and graded after 14 days or 28 days after herbicide application. A grading of 0% reflects a healthy non-treated plant, i.e. the non-treated reference population and 100% represents full efficacy of the herbicide, i.e. a deceased plant. For reference the two commercial suspension concentrates Balance™ Pro (isoxaflutole without safener) and Brodal® (diflufenican) were chosen.

Particle sizes and zeta potentials for formulations obtained to process A were determined via laser diffraction (Malvern Mastersizer S) in aqueous solution: typical dilution 1:1000 of as synthesized formulation. Zeta potential of the dispersions was measured using a Malvern Zetasizer ZS90 in 1 mM KCl as a function of pH; typical dilution 1:100 to 1:1000 of as synthesized formulation.

All other particle sizes were determined through laser diffraction using a Malvern mastersizer hydro 3000s. All samples were measured by dispersing in water and applying ultrasound for 300 sec prior to the measurement. Scattering Modell: Fraunhofer; analysis tool: universal

Active content of all formulations according to process A was determined using a thermogravimetric analysis, fully evaporating the aqeuous phase at 160° C. and measuring the residual dry mass and calculating the active content based on the employed manufacturing ratio (dispersion concentrate vs polymer solution). The obtained dry mass was corrected for the fluopyram to stabilizer mass in the dispersion concentrate, i.e. 48% fluopyram and 3% inerts in the dispersion concentrate.

Release kinetics of the active into pure water were analyzed using a HPLC assay. The method can be used to either analyze the release from the formulated suspension or to evaluate release kinetics from a dry application mixture. The following process was used for determination of release from aqueous dispersions (CS, SC or FS type formulation). A LiChroCart Purosher Star PR-18e, 3.0 μm was used with an isocratic gradient: 50% 0.1% phosphoric acid and 50% acetonitrile.

For examination of aqueous dispersion type formulations, incl. CS/SC/FS, an aliquot of the formulation was placed in 1.0 L of purified water and shook on an orbital shaker at the lowest reasonable speed, i.e. 50-100 rpm. The added volume of the formulation was carefully chosen to ensure infinite sink conditions during release. Samples were withdrawn after 1 h and 24 hours, optionally for some samples after 5 & 300 min. In order foster full release for tightly encapsulated formulations, another 100 mL of acetonitrile were added to the mixture after 1 day, continuously shook at unchanged speed for another day, and followed by a last sample withdrawal after 48 hours. Prior to the actual HPLC-analysis, every sample taken was centrifuged to remove particulate (encapsulated) active from the supernatant. The clear supernatant was then submitted for HPLC analysis. The latest data point (48 hours) was taken for normalization of the release to 100%.

When used for treated seeds, ca. 15 g of the treated seeds, were immersed in 500 mL water. Samples were withdrawn and treated as described above.

Controlled release was evident if the release profile was significantly lower than for a similarly formulated non-encapsulated sample, i.e. less than 50% release at a given point in time.

Encapsulation efficiency EE was determined using the release FLU concentration within the first 10 minutes. i.e. EE=1−[c(FLU-encapsulated,10 min)/c(FLU-reference, 10 min)].

### Process a (Coating of Fluopyram Using a Microjet Reactor Process Plus Optional Cross-Linking)

According to process 1—to obtain the encapsulated materials—the active is homogenized in water with surfactants and subsequently milled, preferably in a bead mill, to obtain a dispersion concentrate of the active.

In a second step the active containing suspension is mixed in a microjet reactor (cf. e.g. nanoSaar; http://www.nanosaar.de/nanosaarlabgmbh/) with a polymer solution to obtain a non-crosslinked encapsulation. More preferred mixing takes place at a pressure of 50-60 bar with jet velocities of ˜100 m/S and a mixing time of 0.1-1.0 ms. Furthermore preferred pH of the either/or the dispersion concentrate and polymer solution is adjusted prior to high shear mixing in the microjet reactor according to the polymer used, for example, for polyvinylalcohol pH is preferably between 4 and 5 (measured with pH-glass electrode OPS11), while the pH for Chitosan is preferably between 11 and 12.

Optionally, in a third step the particles obtained in the steps above are crosslinked for stabilization and/or to control the release properties of the particles.

The so obtained encapsulation may not be fully tethered to the active surface but may contain loosely attached or unbound polymers or a highly swollen polymer gel. As a consequence the degree of control release, i.e. active release may change with the final application, i.e. drying of the formulation upon seed treatment. Likewise curing/aging/drying may significantly alter the release profile/rate.

Preferably the active compounds for encapsulation according to the invention are selected from the group comprising Fluopyram, Flupyradifurone, Diflufenican, Isoxaflutole, Imidacloprid and Isotianil.

In one embodiment the active compound is Fluopyram.

In another embodiment the active compound is selected from the group comprising Fluopyram, Flupyradifurone, Diflufenican, Isoxaflutole, Imidacloprid and Isotianil.

More preferred the active compound is Fluopyram.

In another more preferred embodiment the active compounds are selected from the group comprising Diflufenican and Isoxaflutole.

Preferred cross-linking agents are formaldehyde (FA), glutaraldehyde (GA), terephthalaldehyde (TA), or mixtures thereof.

Preferred surfactants are anionic surfactants, more preferred naphthalene sulphonate formaldehyde condensate Na salts and sodium polycarboxylate.

Preferred polymers for encapsulation are water soluble polymers and hydrogel forming homo and co polymers, more preferred acrylate copolymers, in particular amine acrylates, chitosan and polyvinylalcohols (PVA) either being fully hydrolysed or partially hydrolyzed polyvinylacetates, most preferred are chitosan and polyvinylalcohols (PVA) either being fully hydrolysed or partially hydrolyzed polyvinylacetates.

In a preferred embodiment the encapsulated actives are produced by first homogenizing 3.388 kg Fluopyram with 140 g of a surfactant of the polycarboxylic acid salt class, preferably a sodium salt, and 70 g of a surfactant of the class of naphthalene sulphonate formaldehyde condensate and 3.4 kg demineralized water. Subsequently the homogenized mixture is milled in a beadmill under wet conditions containing glass beads with a diameter of 0.75-1 mm (Bachofen KDL 0.6 L with Glasbeads, 80% capacity, peripheral speed 10 m/s, 3 passages, turnover 3.4 kg/h). The active suspension produced as above and a solution of a polyaminosachharide, preferably a poly-D-Glucosamin (Chitosan) (parent solution 1.5, 2.0 or 2.5% in water) (alternatively PVA (parent solution 3 or 12% in water)) are reacted in a microjet reactor, Nanosaar, under the following conditions (pressure 50-60 bar, jet velocity˜100 m/s, mixing time 0.1-1.0 ms, pH as indicated in Table 2). Final AI concentrations are provided in cl. 3 and 5 of Table 2. Optionally crosslinker is added (0.5, 3.0, 10.0 or 20.0 mol % based on reactive groups of the polymer.

### FIGURES

FIG. 1: Rating criteria for visual cotyledon test

FIG. 2: Leaf damages on cucumber plants after fluopyram treatment as a function of release profiles and application rates. Graph visualizes data of Table 8.

FIG. 3: release profiles into water

FIG. 4: Particle size distribution of as obtained formulations; Laser diffraction—Malvern mastersizer hydro 3000s

FIG. 5: Root lesion nematode bioassay conducted on 0.075 mg FLU/seed treated soy; corresponds to Table

FIG. 6: Results of Bioassay for identification of severity of sudden death syndrome (SDS) on soy; Rated for SDS symptoms at first trifoliate using 0-6 scale (0: no symptoms, 6: wilted/dead); inoculated with Fusarium virguiliforme; grown under wet conditions; seeds treated at 0.075 mg FLU/seed; corresponds to Table 15

FIG. 7: Efficacy in gall reduction after treatment with CR-fluopyram formulations.

FIG. 8: release profiles into water, FLU-reference formulation was identical to C-1 to C-11

FIG. 9: Canopy analysis of cotyledons for selected samples—n=60 plants

FIG. 10: Cotyledon area (cm²) of soy after treatment with controlled release formulations compared to references, higher FLU rate applied for treatment @ 0.15 mg FLU/seed—dark=healthy leave area; light grey=Halo area

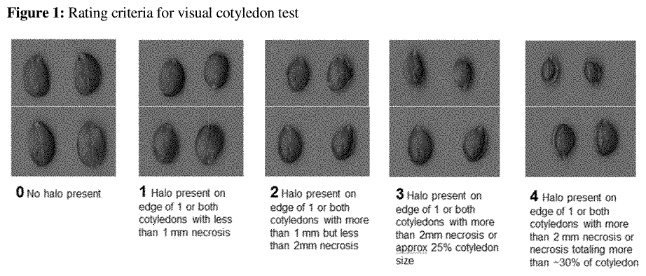

The encapsulation method as well as the products and their properties are described in the examples below.

### EXAMPLE PROCESS A

The Materials used are defined in below. The production process itself was divided into: production of A.1 dispersion concentrate—A.2 encapsulation—A.3 crosslinking.

### A.1 Production of the Dispersion Concentrate Fluopyram for A-1 to A-107

3.388 kg Fluopyram are homogenized with 140 g Geropon T36, 70 g Morwet D 425 and 3.4 kg demineralized water. Subsequently the homogenized mixture is milled in a beadmill under wet conditions containing glass beads with a diameter of 0.75-1 mm (Bachofen KDL 0.6 L with Glasbeads, 80% capacity, peripheral speed 10 m/s, 3 passages, turnover 3.4 kg/h). Subsequently, a 40% active dispersion of Fluopyram slurry is prepared by dilution of a concentrated slurry (solid content: 48% active, 3% inert stabilizer/surfactants) with DI water.

### A.2 Production of the Dispersion Concentrate Isoxaflutole for A-10 to A-111

968 g Isoxaflutole are homogenized with 40 g Geropon T36, 20 g Morwet D 425, 1 g Silfoam SE 39 and 968 g demineralized water. Subsequently the homogenized mixture is milled in a beadmill under wet conditions containing glass beads with a diameter of 0.75-1 mm (Bachofen KDL 0.6 L with Glasbeads, 80% capacity, peripheral speed 10 m/s, 3 passages (repetitions may be adjusted to yield required particle size), turnover 3.4 kg/h). Subsequently, pH was adjusted by additional citric acid to <5.

### A.3 Production of the Dispersion Concentrate Diflufenican for A-112 and A-113

968 g Diflufenican are homogenized with 40 g Geropon T36, 20 g Morwet D 425 and 968 g demineralized water. Subsequently the homogenized mixture is milled in a beadmill under wet conditions containing glass beads with a diameter of 0.75-1 mm (Bachofen KDL 0.6 L with Glasbeads, 80% capacity, peripheral speed 10 m/s, 3 passages (repetitions may be adjusted to yield required particle size), turnover 3.4 kg/h).

### A.2 Encapsulation

The active suspension produced as above and a solution of Chitosan (parent solution 0.5, 1.0, 1.5, 2.0 or 2.5% w/w in water) (alternatively PVA (parent solution 3 or 12% w/w in water)) are homogenized in a symmetric 200 μm microjet reactor, Nanosaar, under the following conditions (pressure 50-60 bar, jet velocity ≥100 m/s, mixing time 0.1-1.0 ms, pH as indicated in Table 2). Final polymer and AI concentrations are provided in cl. 4 and 5 of Table 2.

Briefly, the 40 wt % aqueous dispersion comprising fluopyram dispersion having >90 wt % of particles smaller than 1 μm and an anionic dispersant was adjusted to pH=13.5 by addition of 5M NaOH (alternatively pH=4 for PVA-coating, adjusted with glacial acetic acid). This solution was processed against a chitosan solution set to pH=4 (alternatively, pH=6.7 for the PVA in DI water) in a MJR reactor. Flow rates of solutions were adjusted by pump rate to a mass ratio of about 1 (Chitosan coating solution) to 2 (Fluopyram slurry). Processing was conducted at room temperature in a symmetric MJR (200 μm ruby nozzles) reactor by impinging chitosan solution with fluopyram dispersion at a hydrodynamic pressure of 50 to 60 bar to yield chitosan coated fluopyram dispersion. For cross-linking 10 mol % of Glutaraldehyde (with respect to chitosan) can be added to the fluopyram dispersion prior to processing by MJR or in a separate post-processing step, details see below.

### A.3 Crosslinking

Optionally crosslinker is added (0.5, 3.0, 10.0 or 20.0 mol % based on reactive groups of the polymer. Cross linker solutions were employed as obtained by the supplier and can either be added to the active dispersion prior to the coating process or added under stirring to the final formulation after coating via MJR. Typically the amount of cross-linker was added prior to the coating process. After MJR processing cross-linking was conducted for at least 12 h at room temperature at the resulting pH shown in Table 2. The cross-linking reaction was allowed react without any quenching, such as typically employed tris-buffer or ammonium chloride quenching.

Formaldehyde (FA) was used as 37% (w/w) in water and Glutaraldehyde (GA) in 25% (w/w) in water.

For aldehyde crosslinking pH, reaction temperature and reaction time was adjusted to control the release rate, cl. 101 Table 2.

TABLE 2
encapsulated Fluopyrarn, Isoxaflutole and Diflufenican according to process A

| | | conc. | | | | | | | | |
|---|---|---|---|---|---|---|---|---|---|---|
| | | Parent | final | | | | | | | |
| | | polymer | conc. | final ai | | cross- | | | release | zeta |
| | polymer | solution | Polymer | conc. | cross- | linker | | visual | [1 h, in | potential |
| entry | type | [%] | [% w/w] | [% w/w] | linker | [mol %] | pH | appearance | water] | [mV] |
| A-1 | PVA: 10-98 | 3 | 1.22 | 23.7 | no | / | 4.3 | liquid dispersion | 87% | n.d. |
| A-2 | PVA: 10-98 | 3 | 1.22 | 23.7 | GA | 0.50 | 4.3 | liquid dispersion | 64% | n.d. |
| A-3 | PVA: 10-98 | 3 | 1.22 | 23.7 | GA | 3.00 | 4.3 | liquid dispersion | 86% | n.d. |
| A-4 | PVA: 10-98 | 3 | 1.22 | 23.7 | GA | 10.00 | 4.3 | liquid dispersion | 78% | n.d. |
| A-5 | PVA: 10-98 | 12 | 4.29 | 25.7 | no | / | 4.3 | liquid dispersion | 66% | n.d. |
| A-6 | PVA: 10-98 | 12 | 4.29 | 25.7 | GA | 0.50 | 4.3 | gelling after | 3% | n.d. |
| | | | | | | | | several days | | |
| A-7 | PVA: 10-98 | 12 | 4.29 | 25.7 | GA | 3.00 | 4.3 | gelling after | n.d. | n.d. |
| | | | | | | | | several days | | |
| A-8 | PVA: 10-98 | 12 | 4.29 | 25.7 | GA | 10.00 | 4.3 | imediate gelling | n.d. | n.d. |
| A-9 | PVA: 8-88 | 3 | 0.93 | 27.6 | no | / | 4.3 | liquid dispersion | 58% | n.d. |
| A-10 | PVA: 8-88 | 3 | 0.93 | 27.6 | GA | 0.50 | 4.3 | liquid dispersion | 81% | n.d. |
| A-11 | PVA: 8-88 | 3 | 0.93 | 27.6 | GA | 3.00 | 4.3 | liquid dispersion | 75% | n.d. |
| A-12 | PVA: 8-88 | 3 | 0.93 | 27.6 | GA | 10.00 | 4.3 | liquid dispersion | 28% | n.d. |
| A-13 | PVA: 8-88 | 12 | 3.93 | 26.9 | no | / | 4.3 | liquid dispersion | 89% | n.d. |
| A-14 | PVA: 8-88 | 12 | 3.93 | 26.9 | GA | 0.50 | 4.3 | gelling after | 3% | n.d. |
| | | | | | | | | several days | | |
| A-15 | PVA: 8-88 | 12 | 3.93 | 26.9 | GA | 3.00 | 4.3 | gelling after | n.d. | n.d. |
| | | | | | | | | several days | | |
| A-16 | PVA: 8-88 | 12 | 3.93 | 26.9 | GA | 10.00 | 4.3 | imediate gelling | n.d. | n.d. |
| A-17 | PVA: 20-98 | 3 | 1.00 | 26.7 | no | / | 4.2 | liquid dispersion | 99% | n.d. |
| A-18 | PVA: 20-98 | 3 | 1.00 | 26.7 | GA | 0.50 | 4.2 | liquid dispersion | 95% | n.d. |
| A-19 | PVA: 20-98 | 3 | 1.00 | 26.7 | GA | 3.00 | 4.3 | liquid dispersion | 98% | n.d. |
| A-20 | PVA: 20-98 | 3 | 1.00 | 26.7 | GA | 10.00 | 4.3 | liquid dispersion | 76% | n.d. |
| A-21 | PVA: 20-98 | 12 | 2.87 | 30.4 | no | / | 4.2 | liquid dispersion | 73% | n.d. |
| A-22 | PVA: 20-98 | 12 | 2.87 | 30.4 | GA | 0.50 | 4.3 | liquid dispersion | 56% | n.d. |
| A-23 | PVA: 20-98 | 12 | 2.87 | 30.4 | GA | 3.00 | 4.2 | imediate gelling | n.d. | n.d. |
| A-24 | PVA: 20-98 | 12 | 2.87 | 30.4 | GA | 10.00 | 4.2 | imediate gelling | n.d. | n.d. |
| A-25 | 1PVA: 8-88 | 3 | 1.02 | 26.4 | no | / | 4.0 | liquid dispersion | 68% | n.d. |
| A-26 | 1PVA: 8-88 | 3 | 1.02 | 26.4 | GA | 0.50 | 4.1 | liquid dispersion | 96% | n.d. |
| A-27 | 1PVA: 8-88 | 3 | 1.02 | 26.4 | GA | 3.00 | 4.1 | liquid dispersion | 93% | n.d. |
| A-28 | 1PVA: 8-88 | 3 | 1.02 | 26.4 | GA | 10.00 | 4.1 | liquid dispersion | 95% | n.d. |
| A-29 | 1PVA: 8-88 | 12 | 2.50 | 31.7 | no | / | 4.2 | liquid dispersion | 75% | n.d. |
| A-30 | 1PVA: 8-88 | 12 | 2.50 | 31.7 | GA | 0.50 | 4.3 | liquid dispersion | 81% | n.d. |
| A-31 | 1PVA: 8-88 | 12 | 2.50 | 31.7 | GA | 3.00 | 4.2 | imediate gelling | n.d. | n.d. |
| A-32 | 1PVA: 8-88 | 12 | 2.50 | 31.7 | GA | 10.00 | 4.2 | imediate gelling | n.d. | n.d. |
| A-33 | PVA: 56-98 | 3 | 0.98 | 26..9 | no | / | 4.3 | liquid dispersion | 76% | n.d. |
| A-34 | PVA: 56-98 | 3 | 0.98 | 26.9 | GA | 0.50 | 4.2 | liquid dispersion | 63% | n.d. |
| A-35 | PVA: 56-98 | 3 | 0.98 | 26.9 | GA | 3.00 | 4.2 | gelling after | 5% | n.d. |
| | | | | | | | | several days | | |
| A-36 | PVA: 56-98 | 3 | 0.98 | 26.9 | GA | 10.00 | 4.3 | gelling after | 8% | n.d. |
| | | | | | | | | several days | | |
| A-37 | PVA: 56-98 | 12 | 2.94 | 30.2 | no | / | 4.3 | liquid dispersion | 42% | n.d. |
| A-38 | PVA: 56-98 | 12 | 2.94 | 30.2 | GA | 0.50 | 4.3 | gelling after | 7% | n.d. |
| | | | | | | | | several days | | |
| A-39 | PVA: 56-98 | 12 | 2.94 | 30.2 | GA | 3.00 | 4.3 | imediate gelling | n.d. | n.d. |
| A-40 | PVA: 56-98 | 12 | 2.94 | 30.2 | GA | 10.00 | 4.3 | imediate gelling | n.d. | n.d. |
| A-41 | PVA: 40-88 | 3 | 0.99 | 26.8 | no | / | 4.3 | liquid dispersion | 76% | n.d. |
| A-42 | PVA: 40-88 | 3 | 0.99 | 26.8 | GA | 0.50 | 4.3 | liquid dispersion | 28% | n.d. |
| A-43 | PVA: 40-88 | 3 | 0.99 | 26.8 | GA | 3.00 | 4.3 | liquid dispersion | 16% | n.d. |
| A-44 | PVA: 40-88 | 3 | 0.99 | 26.8 | GA | 10.00 | 4.3 | gelling after | 12% | n.d. |
| | | | | | | | | several days | | |
| A-45 | PVA: 40-88 | 12 | 2.72 | 30.9 | no | / | 4.3 | liquid dispersion | 68% | n.d. |
| A-46 | PVA: 40-88 | 12 | 2.72 | 30.9 | GA | 0.50 | 4.3 | gelling after | 6% | n.d. |
| | | | | | | | | several days | | |
| A-47 | PVA: 40-88 | 12 | 2.72 | 30.9 | GA | 3.00 | 4.3 | gelling after | n.d. | n.d. |
| | | | | | | | | several days | | |
| A-48 | PVA: 40-88 | 12 | 2.72 | 30.9 | GA | 10.00 | 4.2 | imediate gelling | n.d. | n.d. |
| A-49 | PVA: 8-88 | 3 | 1.02 | 26.4 | FA | / | 4.3 | liquid dispersion | 78% | n.d. |
| A-50 | PVA: 8-88 | 3 | 1.02 | 26.4 | FA | / | 4.3 | liquid dispersion | 92% | n.d. |
| A-51 | PVA: 8-88 | 12 | 3.62 | 27.9 | FA | / | 4.3 | liquid dispersion | 79% | n.d. |
| A-52 | PVA: 8-88 | 12 | 3.62 | 27.9 | FA | / | 4.3 | liquid dispersion | 93% | n.d. |
| A-55 | Chitosan-low | 1.5 | 0.81 | 29.2 | no | / | 11.61 | liquid dispersion | 84% | n.d. |
| A-56 | Chitosan-low | 1.5 | 0.81 | 29.2 | GA | 0.5 | 11.45 | liquid dispersion | 86% | n.d. |
| A-57 | Chitosan-low | 1.5 | 0.81 | 29.2 | GA | 3.0 | 11.61 | liquid dispersion | 74% | n.d. |
| A-58 | Chitosan-low | 1.5 | 0.81 | 29.2 | GA | 10.0 | 11.84 | liquid dispersion | 73% | n.d. |
| A-59 | Chitosan-low | 2.0 | 0.97 | 27.0 | no | / | 11.59 | liquid dispersion | 88% | n.d. |
| A-60 | Chitosan-low | 2.0 | 0.97 | 27.0 | GA | 0.5 | 11.84 | liquid dispersion | 87% | n.d. |
| A-61 | Chitosan-low | 2.0 | 0.97 | 27.0 | GA | 3.0 | 11.89 | liquid dispersion | 74% | n.d. |
| A-62 | Chitosan-low | 2.0 | 0.97 | 27.0 | GA | 10.0 | 11.88 | liquid dispersion | 80% | n.d. |
| A-63 | Chitosan-low | 2.5 | 1.05 | 26.0 | no | / | 11.77 | liquid dispersion | 86% | n.d. |
| A-64 | Chitosan-low | 2.5 | 1.05 | 26.0 | GA | 0.5 | 11.74 | liquid dispersion | 83% | n.d. |
| A-65 | Chitosan-low | 2.5 | 1.05 | 26.0 | GA | 3.0 | 11.74 | liquid dispersion | 73% | n.d. |
| A-66 | Chitosan-low | 2.5 | 1.05 | 26.0 | GA | 10.0 | 11.76 | liquid dispersion | 81% | n.d. |
| A-67 | Chitosan-high | 0.5 | 0.86 | 28.6 | no | / | 11.85 | liquid dispersion | 92% | n.d. |
| A-68 | Chitosan-high | 0.5 | 0.86 | 28.6 | GA | 0.5 | 11.87 | liquid dispersion | 100% | n.d. |
| A-69 | Chitosan-high | 1.0 | 0.86 | 28.5 | no | / | 11.82 | liquid dispersion | 44% | n.d. |
| A-70 | Chitosan-high | 1.0 | 0.86 | 28.5 | GA | 0.5 | 11.76 | liquid dispersion | 95% | n.d. |
| A-71 | Chitosan-high | 1.5 | 0.93 | 27.6 | no | / | 11.72 | liquid dispersion | 92% | n.d. |
| A-72 | Chitosan-high | 1.5 | 0.93 | 27.6 | GA | 0.5 | 11.69 | liquid dispersion | 91% | n.d. |
| A-73 | Chitosan-high | 1.5 | 0.93 | 27.6 | GA | 3.0 | 11.67 | liquid dispersion | 83% | n.d. |
| A-74 | Chitosan-high | 1.5 | 0.93 | 27.6 | GA | 10.0 | 11.56 | imediate gelling | 91% | n.d. |
| A-75 | Chitosan-low | 1.5 | 0.81 | 29.2 | FA | 3.0 | 11.55 | liquid dispersion | 96% | n.d. |
| A-76 | Chitosan-low | 1.5 | 0.81 | 29.2 | FA | 20.0 | 11.78 | liquid dispersion | 87% | n.d. |
| A-77 | Chitosan-low | 2.0 | 0.97 | 27.0 | FA | 3.0 | 11.77 | liquid dispersion | 95% | n.d. |
| A-78 | Chitosan-low | 2.0 | 0.97 | 27.0 | FA | 20.0 | 11.72 | liquid dispersion | 85% | n.d. |
| A-79 | Chitosan-low | 2.5 | 1.05 | 26.0 | FA | 3.0 | 11.63 | liquid dispersion | 76% | n.d. |
| A-80 | Chitosan-low | 2.5 | 1.05 | 26.0 | FA | 20.0 | 11.64 | liquid dispersion | 60% | n.d. |
| A-81 | Chitosan-low | 1.5 | 0.81 | 29.2 | TA | 3.0 | 11.76 | liquid dispersion | 60% | n.d. |
| A-82 | Chitosan-low | 2.0 | 0.97 | 27.0 | TA | 3.0 | 11.82 | liquid dispersion | 75% | n.d. |
| A-83 | Chitosan-low | 2.5 | 1.05 | 26.0 | TA | 3.0 | 11.76 | liquid dispersion | 74% | n.d. |
| A-84 | Atlox 4915 | 1 | n.d. | 8.6 | no | / | 3.06 | liquid dispersion | n.d. | 49.4 |
| A-85 | Atlox 4915 | 1 | n.d. | 8.6 | no | / | 4.05 | liquid dispersion | n.d. | 50.1 |
| A-86 | Atlox 4915 | 1 | n.d. | 8.6 | no | / | 5.01 | liquid dispersion | 93% | 53 |
| A-87 | Atlox 4915 | 1 | n.d. | 8.6 | no | / | 6.04 | liquid dispersion | 95% | 54 |
| A-88 | Atlox 4915 | 1 | n.d. | 8.6 | no | / | 6.94 | liquid dispersion | 92% | 53.2 |
| A-89 | Atlox 4915 | 1 | n.d. | 8.6 | no | / | 5.08 | liquid dispersion | 90% | 53 |
| A-90 | Atlox 4915 | 1 | n.d. | 16.9 | no | / | 4.34 | liquid dispersion | 67% | −26.4 |
| A-91 | Synprolam | 1 | n.d. | 9.6 | no | / | n.d. | liquid dispersion | n.d. | −26.3 |
| A-92 | Synprolam | 2 | n.d. | 19.2 | no | / | n.d. | liquid dispersion | n.d. | −24.9 |
| A-93 | Synprolam | 4 | n.d. | 38.4 | no | / | n.d. | liquid dispersion | n.d. | −27.8 |
| A-94 | PVA | 4 | n.d. | 8.6 | no | / | 5.05 | liquid dispersion | 93% | −8.14 |
| A-95 | PVA | 4 | n.d. | 8.6 | GA | 1.0 | 5.01 | liquid dispersion | 94% | −11.9 |
| A-96 | PVA | 2 | n.d. | 16.1 | no | / | 4.22 | liquid dispersion | 75% | −37.2 |
| A-97 | PVA | 2 | n.d. | 18.6 | GA | 1.0 | 4.33 | liquid dispersion | 86% | −35.9 |
| A-98 | PVA | 2 | n.d. | 17.6 | GA | 2.0 | 4.24 | liquid dispersion | 78% | −36.6 |
| A-99 | PVA | 2 | n.d. | 15.4 | GA | 4.0 | 4.3 | liquid dispersion | 73% | −36.7 |
| A-100 | PVA/Eudragit | 2/1 | n.d. | 18.0 | no | / | 4.3 | liquid dispersion | 74% | −37.4 |
| | RS30D | | | | | | | | | |
| A-101 | PVA/Eudragit | 2/2 | n.d. | 16.6 | no | / | 4.2 | liquid dispersion | 75% | −34.8 |
| | RS30D | | | | | | | | | |
| A-102 | PVA/Eudragit | 2/4 | n.d. | 17.4 | no | / | 4.26 | liquid dispersion | 82% | −33 |
| | RS30D | | | | | | | | | |
| A-103 | Chitosan-low | 1 | n.d. | 15.2 | no | / | 4.24 | liquid dispersion | 61% | 58.6 |
| A-104 | Chitosan-low | 0.5 | n.d. | 18.2 | no | / | 4.17 | liquid dispersion | 55% | 33.5 |
| A-105 | Chitosan-low | 0.75 | n.d. | 17.3 | no | / | 4.26 | liquid dispersion | 53% | 47 |
| A-106 | Chitosan-low | 1.5 | n.d. | 29.1 | no | / | 4.27 | liquid dispersion | 58% | −31.6 |
| A-107 | n/a | n/a | n/a | 48.0 | no | n/a | n.d. | liquid dispersion | 96% | −37.7 |
| (ref) | | | | | | | | | | |
| A-108 | PVA: 8-88 | 3 | 1 | 32.3 | no | / | <5 | liquid dispersion | 45% | n.d. |
| A-109 | PVA: 56-98 | 3 | 1 | 32.3 | GA | 1.0 | <5 | liquid dispersion | 37% | n.d. |
| A-110 | PVA: 8-88 | 12 | 4 | 32.3 | GA | 1.0 | <5 | liquid dispersion | 2% | n.d. |
| A-111 | PVA: 56-98 | 12 | 4 | 32.3 | no | / | <5 | liquid dispersion | 10% | n.d. |
| A-112 | PVA: 56-88 | 6 | 2 | 26.9 | no | / | <5 | liquid dispersion | n.d. | n.d. |
| A-113 | PVA: 56-98 | 3 | 1 | 27.8 | no | / | <5 | liquid dispersion | n.d. | n.d. |

In a preferred embodiment, the amount of polymer for encapsulation in the parent solution is from 0.5 to 15 more preferred from 1 to 12%, even more preferred from 1 to 10%, even further preferred from 1 to 8, and most preferred from 1 to 6%.

In a further preferred embodiment the crosslinker is selected from the group consisting of formaldehyde and glutaraldehyde, wherein the crosslinker, if applied, is present the parent solution preferably in an amount of 0.2 to 13%, more preferably from 0.5 to 12%, and most preferred from 0.5 to 10%.

If the crosslinker is glutaraldehyde, in a preferred embodiment the amount of crosslinker in the parent solution is from 0.5 to 5%.

TABLE 3
Exemplary summary of typical particle sizes
obtained according to process A.

| Example | mean particle size [μm] |
|---|---|
| A-90 | 5.95 |
| A-96 | 1.54 |
| A-103 | 5.44 |

TABLE 4
Exemplary zeta potential variation with pH shown
for example A-107 (Fluopyram without coating)

| pH | Zeta potential [mV] |
|---|---|
| 3 | −38 |
| 4 | −50 |
| 5 | −51 |
| 6 | −53 |
| 7 | −56 |
| 8 | −55 |
| 9 | −58 |
| 10 | −56 |

Zeta potential measurements can be used to validate the successful coating process. The zeta potential of the non controlled-release coated fluopyram is highly negative within a broad pH range. i.e. at least between pH 3-10, cf. Table 4, indicating the high potential for adsorption of neutral or positively charged polymers. The strongly negative charge of −38 mV of the uncoated fluopyram dispersion, cf. Table 2: A-107, becomes more positive upon PVA coating due to shielding, eventually reaching −8 mV and −12 mV for anon-cross-linked and crosslinked PVA, respectively (cf. Table 2 A-94 & A-95). Due to the highly positive charge of a protonated chitosan the zeta potential undergoes a full inversion of the charge finally reaching +59 mV upon coating (cf. Table 2. A-103).

### Visual Inspection:

All samples were inspected visually for either phase separation by sedimentation of particles or gelation. As opposed to sedimentation gelation was irreversible and these samples cannot be employed for spray type applications, examples for gelation are marked in Table 2. All samples in which phase separation was observed could easily be homogenized by shaking.

### Seed Treatments and Biology Tests for Formulations Obtained According to Process A

Samples were supplied as aqueous suspensions and were applied to soybean seeds at a rate of 0.075 mg/seed using 100-250 g of seeds in a small or medium sized Hege bowl seed treater, cf. Table 5.

TABLE 5
Concentration of FLU (w/w %) on
treated seeds obtained through process A

| Entry | [FLU] | Entry | [FLU] | Entry | [FLU] |
|---|---|---|---|---|---|
| A-100 | 18.0 | A-98 | 17.6 | A-2 | 23.70 |
| A-101 | 16.6 | A-99 | 15.4 | A-5 | 25.70 |
| A-102 | 17.4 | A-86 | 8.6 | A-9 | 27.56 |
| A-103 | 15.2 | A-87 | 8.6 | A-11 | 27.56 |
| A-104 | 18.2 | A-88 | 8.6 | A-12 | 26.56 |
| A-105 | 17.3 | A-89 | 8.6 | A-25 | 26.40 |
| A-106 | 29.1 | A-90 | 16.9 | A-34 | 26.88 |
| A-94 | 8.6 | A-69 | 28.47 | A-37 | 30.22 |
| A-95 | 8.6 | A-81 | 29.24 | A-42 | 26.78 |
| A-96 | 16.1 | A-66 | 26.02 | A-44 | 26.78 |
| A-97 | 18.6 | A-80 | 26.02 | A-45 | 30.94 |

TABLE 6
Summary on greenhouse results obtained for soy
treated with formulations obtained according to
process A, lines with references, i.e. UTC and FLU-
reference, indicate the start of a new greenhouse
testing series. A-9 was found to have the lowest
halo, even though not as low as the untreated control
but significantly improved compared to the
standard fluopyram treatment.

| Entry | Sample ID | Halo Rating |
|---|---|---|
| UTC | Untreated | 0.0 |
| FLU-ref | FLU FS 600 | 2.86 |
| A-69 | P2-Ch5 | 1.93 |
| A-81 | P2-Ch24 | 1.89 |
| A-66 | P2-Ch19 | 2.67 |
| A-2 | P2-63k-2 | 2.63 |
| A-5 | P2-63k-5 | 2.10 |
| A-9 | P2-63k-9 | 1.07 |
| A-11 | P2-63k-11 | 1.72 |
| UTC | Untreated | 0.00 |
| FLU-ref | FLU FS 600 | 2.07 |
| A-12 | P2-63k-12 | 1.67 |
| A-25 | P2-130k-9 | 1.86 |
| A-34 | P2-205k-2 | 1.12 |
| A-37 | P2-205k-5 | 1.60 |
| A-42 | P2-205k-10 | 1.18 |
| A-44 | P2 -205k-12 | 1.62 |
| A-45 | P2-205k-13 | 1.55 |
| A-80 | P2-Ch29 | 1.67 |

TABLE 7
Summary on greenhouse results obtained for soy treated with formulations obtained according
to process A, lines with references, i.e. UTC and FLU-reference, indicate the start of a new
greenhouse testing series. In this series A-97 and A-100 were found to have the lowest halo,
even though not as low as the untreated control but significantly improved compared to the
standard fluopyram treatment.

| | | | | | Results | | |
|---|---|---|---|---|---|---|---|
| | | Cotyledon Leaf Area (cm²) | | | | Plant | Unifoliate |
| Entry | Sample ID | Total | Healthy | Halo | Halo % | Height (cm) | Area (cm²) |
| UTC | Untreated | 1.8699 | 1.8340 | 0.0359 | 1.92 | 6.82 | 6.60 |
| FLU-ref | FLU FS 600 | 1.1779 | 0.8052 | 0.3727 | 31.64 | 6.53 | 5.62 |
| A-100 | FL-RS30D-1 | 1.2764 | 1.0279 | 0.2485 | 19.47 | 6.84 | 4.78 |
| A-101 | FL-RS30D-2 | 1.2605 | 0.9497 | 0.3108 | 24.65 | 6.47 | 5.07 |
| A-103 | FL-ChL-1 | 1.3110 | 1.0216 | 0.2895 | 22.08 | 6.97 | 4.58 |
| A-104 | FL-ChL-2 | 1.1907 | 0.8864 | 0.3043 | 25.56 | 5.54 | 4.34 |
| A-105 | FL-ChL-3 | 1.3147 | 1.0271 | 0.2875 | 21.87 | 6.71 | 5.70 |
| A-106 | FL-ChL-4 | 1.2758 | 0.9793 | 0.2966 | 23.25 | 6.62 | 6.54 |
| A-94 | FL-PVA-1 | 1.1784 | 0.8579 | 0.3205 | 27.19 | 6.97 | 5.19 |
| A-95 | FL-PVA-2 | 1.2465 | 0.9572 | 0.2894 | 23.21 | 6.22 | 5.11 |
| A-96 | FL-PVA-3 | 1.2082 | 0.8651 | 0.3431 | 28.40 | 6.45 | 4.53 |
| A-97 | FL-PVA-4 | 1.2119 | 0.9753 | 0.2366 | 19.53 | 6.75 | 4.02 |
| UTC | UTC | 1.7347 | 1.7339 | 0.0008 | 0.05 | 8.44 | 12.73 |
| FLU-ref | FLU FS 600 | 1.1232 | 0.9305 | 0.1927 | 17.16 | 6.86 | 9.17 |
| A-98 | FL-PVA-5 | 1.1144 | 0.9029 | 0.2115 | 18.98 | 7.03 | 8.13 |
| A-99 | FL-PVA-6 | 1.0628 | 0.8537 | 0.2091 | 19.68 | 6.50 | 7.39 |
| A-102 | FL-RS30D-3 | 1.1856 | 0.9868 | 0.1989 | 16.77 | 7.22 | 9.25 |
| A-86 | FL-AT-3 | 1.1240 | 0.9127 | 0.2113 | 18.80 | 7.06 | 7.50 |
| A-87 | FL-AT-4 | 1.1256 | 0.9263 | 0.1992 | 17.70 | 6.79 | 8.45 |
| A-88 | FL-AT-5 | 1.0397 | 0.7898 | 0.2498 | 24.03 | 7.59 | 8.82 |
| A-89 | FL-AT-6 | 1.0273 | 0.7554 | 0.2719 | 26.47 | 6.92 | 8.44 |
| A-90 | FL-AT-7 | 1.0736 | 0.8642 | 0.2094 | 19.50 | 7.37 | 7.76 |

### Fluopyram Biology Tests in Soil Drench Applications for Formulations Obtained According to Process A

Samples were supplied as aqueous suspensions, cf. Table 2, and were applied at 8, 10, 20 mg a.i. per cucumber plant by applying 60 mL soil drenches. Plant health (damage) was examined 3/4/5/7/10 and 14 days after application by visual inspection of leafs (% leaf area with chlorosis+necrosis) and shoot fresh weight measurement. Samples obtained according to process A were tested versus untreated control cucumber plants (UTC) and a non-controlled release fluopyram (Velum® SC400).

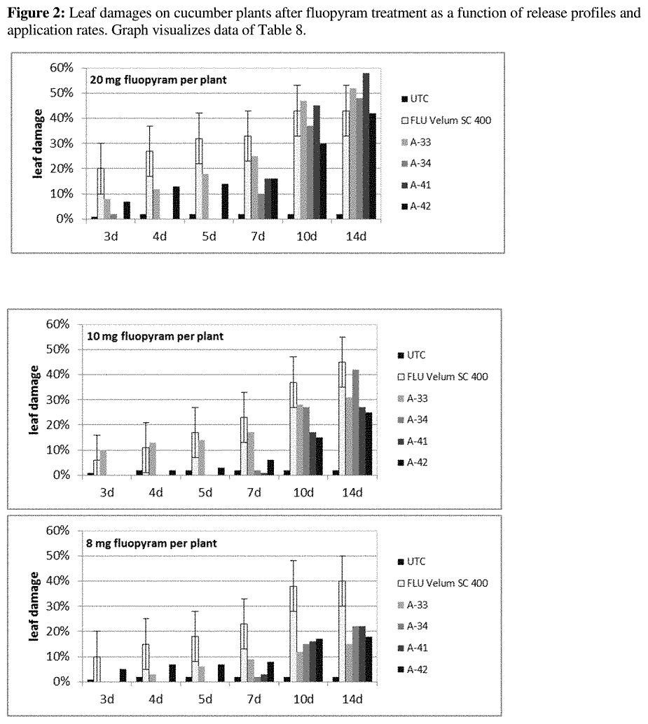

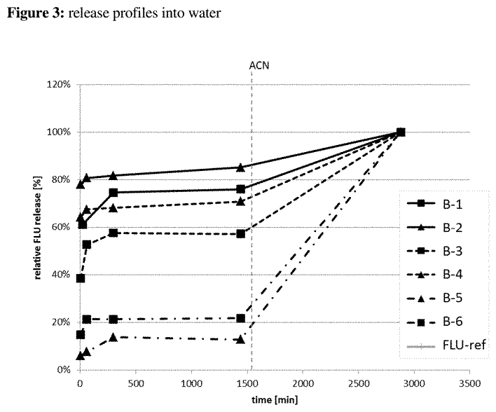

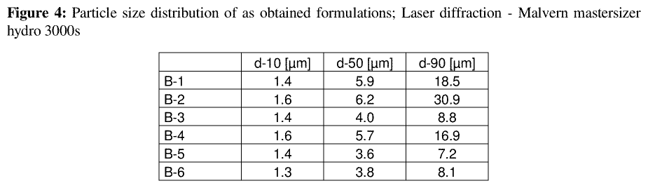

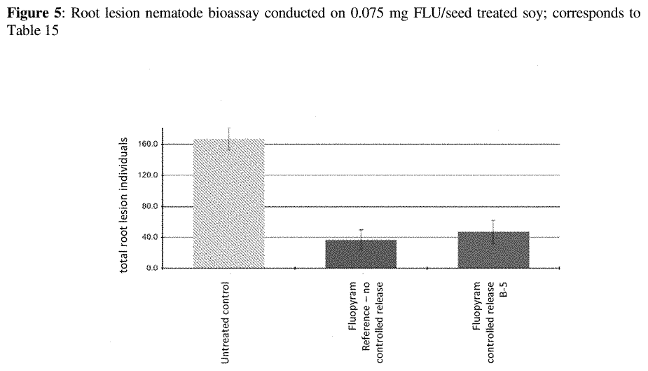

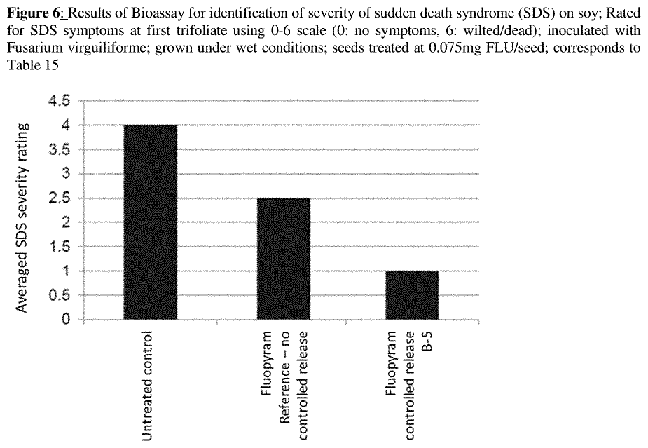

The positive effect obtained from samples formulated according to process A applied on soil varies with the applied dose rate (dose response), and additionally, reflects the controlled release profiles, cf. Table 8 and FIG. 2. Either early reduction of leaf damage (day 0 to 7) at high-dose application of 20 mg fluopyram/plant for samples A-33 and A-34, or, a up to 14 days lasting overall reduction of leaf damage at dose of 8 and 10 mg fluopyram/plant for samples A-41 and A-42 can be obtained.

TABLE 8
Proved phytotoxicity reduction of controlled release formulations obtained according to process
A, % damaged leaf area as a function of time after application and dose rate, i.e. 8, 10, 20 mg
fluopyram per plant. Results represent average of triplicate analysis. Number in bracket indicates
application rate in mg active/plant

| Entry | Sample ID | 3d | 4d | 5d | 7d | 10d | 14d |
|---|---|---|---|---|---|---|---|
| UTC | Untreated | 1% (0) | 2% (0) | 2% (0) | 2% (0) | 2% (0) | 2% (0) |
| FLU-ref | FLU Velum ® | 20% (20) | 27% (20) | 32% (20) | 33% (20) | 43% (20) | 43% (20) |
| | SC 400 | 6% (10) | 11% (10) | 17% (10) | 23% (10) | 37% (10) | 45% (10) |
| | | 10% (8) | 15% (8) | 18% (8) | 23% (8) | 38% (8) | 40% (8) |
| A-33 | CR-formulation | 8% (20) | 12% (20) | 18% (20) | 25% (20) | 47% (20) | 52% (20) |
| | no cross-linking | 10% (10) | 13% (10) | 14% (10) | 17% (10) | 28% (10) | 31% (10) |
| | | 0% (8) | 3% (8) | 6% (8) | 9% (8) | 12% (8) | 15% (8) |
| A-34 | CR-formulation | 2% (20) | n.d. | n.d. | 10% (20) | 37% (20) | 48% (20) |
| | cross-linked shell | 0% (10) | | | 2% (10) | 27% (10) | 42% (10) |
| | | 0% (8) | | | 2% (8) | 15% (8) | 22% (8) |
| A-41 | CR-formulation | 0% (20) | n.d. | n.d. | 16% (20) | 45% (20) | 58% (20) |
| | no cross-linking | 0% (10) | | | 1% (10) | 17% (10) | 27% (10) |
| | | 0% (8) | | | 3% (8) | 16% (8) | 22% (8) |
| A-42 | CR-formulation | 7% (20) | 13% (20) | 14% (20) | 16% (20) | 30% (20) | 42% (20) |
| | cross-linked shell | 0% (10) | 2% (10) | 3% (10) | 6% (10) | 15% (10) | 25% (10) |
| | | 5% (8) | 7% (8) | 7% (8) | 8% (8) | 17% (8) | 18% (8) |

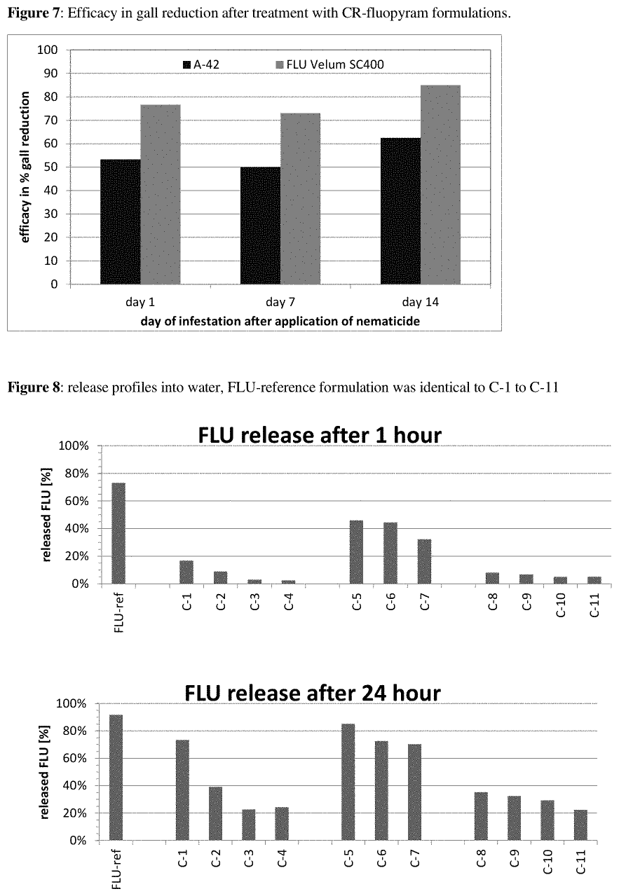

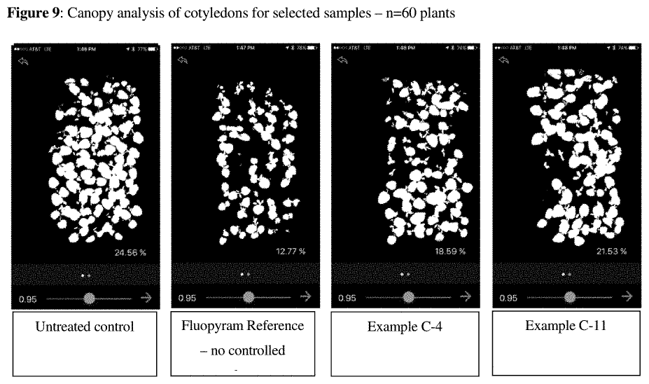

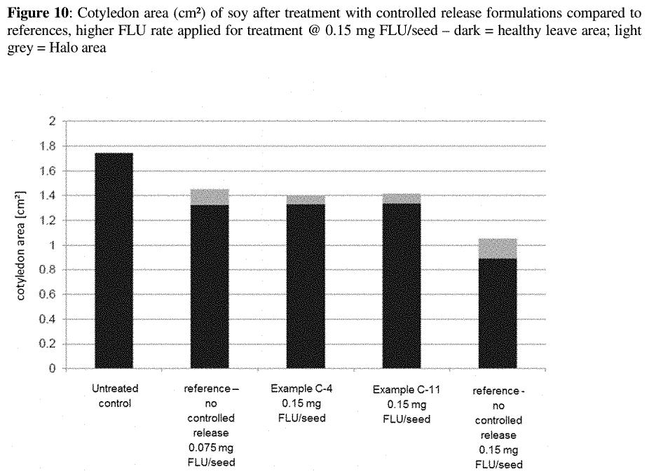

Nematicidal efficacy of a selected sample obtained according to approach A and applied at 1 mg fluopyram per pot. Infestation using Meloidogyne incognita in tomato (Rentita) was done 1, 7 and 14 days after drench treatment (active dispersed in 120 mL water) with the controlled release formulation. Outcome analysis was performed by means of visual inspection of root galling (given in percent). Analysis was carried out in triplicate. The controlled release formulation A-42 was found to have increasing efficacy over time which is a result of its controlled release formulation nature (cf. FIG. 7).

### Herbicide Biology Tests in Soil Spray Applications for Formulations Obtained According to Process A

Samples were supplied as aqueous suspensions, cf. Table 2, and were applied at 50, 100, 200 g active per hectare. Briefly, seeds of grasses, weeds and agricultural crop were seeded in pots with 8 cm diameter in natural soil (slit-rich, non-sterile). Seeds were covered with 0.5 cm of soil and cultivated in a glasshouse (12-16 h light, temperature day 20-22° C., night 15-18° C.). At the BBCH 00 state of growth of the seeds/plants the inventive formulation was applied using a water volume of 300 L/ha. After herbicide treatment all plants were again cultivated in the glasshouse as described above. Daily irrigation was set to 1.0-1.5 liter per square meter. Efficacy of the treatment was assessed by visual grading after 14 days or 28 days, whereas a grading of 0% reflects a healthy non-treated plant, in agreement with the non-treated reference population and 100% represents full efficacy of the herbicide, i.e. a deceased plant. For reference the two commercial products Balance™ Pro (isoxaflutole without safener) and Brodal® (diflufenican) were chosen. Controlled release formulation is A-108 & A-109 of isoxaflutole were compared to the non-controlled release reference Balance™ Pro which contains no safener for treatment of maize plants, cf. Table 9. Independent of the application rate the efficacy profile against common-grasses and weeds was comparable for all formulations in this study. However, at application rates of 50 g/ha and 100 g/ha an improved tolerability against the controlled release formulations A-108 & A-109 is evident. At higher application rates, i.e. 200 g/ha the improved phytotoxicity profile of the controlled release formulation could not be observed.

TABLE 9
Controlled release isoxaflutole herbicide applied
on maize proves the superiority of the controlled
release treatments, “plant damage” (percent).

| | application | non-CR | | |
|---|---|---|---|---|
| | rate [g | reference | | |
| | IFT/ha] | Balance Pro | A-108 | A-109 |
| AVEFA | 50 | 80 | 90 | 90 |
| Avena fatua | 100 | 90 | 95 | 95 |
| | 200 | 97 | 97 | 98 |
| ECHCG | 50 | 99 | 100 | 100 |
| Echinochloa crus- | 100 | 100 | 100 | 100 |
| galli | 200 | 100 | 100 | 100 |
| DIGSA | 50 | 99 | 100 | 100 |
| Digitaria sanguinalis | 100 | 100 | 100 | 100 |
| | 200 | 100 | 100 | 100 |
| SETVI | 50 | 99 | 99 | 95 |
| Setaria viridis | 100 | 99 | 99 | 99 |
| | 200 | 100 | 100 | 100 |
| GALAP | 50 | 70 | 90 | 90 |
| Galium aparine | 100 | 98 | 95 | 95 |
| | 200 | 100 | 95 | 98 |
| CHEAL | 50 | 99 | 99 | 99 |
| Chenopodium | 100 | 99 | 99 | 99 |
| album | 200 | 99 | 100 | 99 |
| POLCO | 50 | 40 | 40 | 30 |
| Polygonum | 100 | 60 | 40 | 50 |
| convolvulus | 200 | 70 | 50 | 80 |
| AMARE | 50 | 100 | 100 | 100 |
| Amaranthus | 100 | 100 | 100 | 100 |
| retroflexus | 200 | 100 | 100 | 100 |
| ZEAMA | 50 | 30 | 0 | 10 |
| Zea mays (maize) | 100 | 70 | 50 | 40 |
| | 200 | 90 | 90 | 95 |

As for the treatment of maize, application of controlled release isoxaflutole formulations on soja is superior to a non-controlled release reference, cf. Balance™ Pro Table 10. Controlled release formulations A-108 to A-111 of isoxaflutole were compared to the non-controlled release reference Balance Pro. Independent of the application rate the efficacy profile against common grasses and weeds was comparable to the reference Brodal pro for tested formulations A-108 and A-109 and somewhat reduced against Avena fatua for A-110 and A-111. Alongside the excellent application profile against weeds and grasses the formulations A-108 to A-111 allowed for varying degrees in improved tolerability of the agricultural crop soya against the herbicidal formulation.

TABLE 10
Controlled release isoxaflutole herbicide applied on maize proves the
superiority of the controlled release treatments, “plant damage” (percent).

| | | non-CR | | | | |
|---|---|---|---|---|---|---|
| | application | reference | | | | |
| | rate [g | Balance | | | | |
| | IFT/ha] | Pro | A-108 | A-109 | A-110 | A-111 |
| AVEFA | 50 | 95 | 95 | 95 | 60 | 30 |
| Avena fatua | 100 | 98 | 97 | 98 | 90 | 40 |
| | 200 | 99 | 99 | 99 | 98 | 95 |
| ECHCG | 50 | 100 | 100 | 100 | 100 | 100 |
| Echinochloa crus-galli | 100 | 100 | 100 | 100 | 100 | 100 |
| | 200 | 100 | 100 | 100 | 100 | 100 |
| DIGSA | 50 | 100 | 100 | 100 | 100 | 100 |
| Digitaria sanguinalis | 100 | 100 | 100 | 100 | 100 | 99 |
| | 200 | 100 | 100 | 100 | 100 | 100 |
| SETVI | 50 | 99 | 99 | 98 | 98 | 90 |
| Setaria viridis | 100 | 99 | 100 | 99 | 99 | 100 |
| | 200 | 100 | 100 | 100 | 99 | 100 |
| GALAP | 50 | 95 | 90 | 85 | 80 | 40 |
| Galium aparine | 100 | 99 | 95 | 95 | 95 | 95 |
| | 200 | 99 | 99 | 99 | 97 | 98 |
| CHEAL | 50 | 100 | 100 | 100 | 100 | 100 |
| Chenopodium album | 100 | 100 | 100 | 100 | 100 | 100 |
| | 200 | 100 | 100 | 100 | 100 | 100 |
| POLCO | 50 | 30 | 30 | 20 | 20 | 10 |
| Polygonum convolvulus | 100 | 50 | 50 | 70 | 30 | 30 |
| | 200 | 50 | 85 | 85 | 70 | 80 |
| AMARE | 50 | 100 | 100 | 100 | 100 | 100 |
| Amaranthus retroflexus | 100 | 100 | 100 | 100 | 100 | 100 |
| | 200 | 100 | 100 | 100 | 100 | 100 |
| GLXMA | 50 | 50 | 10 | 20 | 20 | 20 |
| Glycine max (soja) | 100 | 60 | 30 | 40 | 40 | 40 |
| | 200 | 95 | 95 | 80 | 70 | 80 |

Controlled release formulations A-112 & A-113 of herbicide diflufenican were compared to the non-controlled release reference Brodal, cf. Table 11. Independent of the application rate the efficacy profile against common grasses and weeds was comparable (A-112) or better (A-113) in this study. Alongside the herbicidal efficacy profile the tolerability of soja against both controlled release formulations significantly increased for both tested application rates on soja. For the high application rate of the controlled release formulations of 100 g/ha plant damage was reduced to ¼^{th} compared to the non-CR reference Brodal.

TABLE 11
Controlled release formulations of herbicide diflufenican
applied on soja proves the superiority of the controlled
release treatments, “plant damage” (percent).

| | application | non-CR | | |
|---|---|---|---|---|
| | rate | reference | | |
| | [g DFF/ha] | Brodal | A-112 | A-113 |
| AVEFA | 50 | 30 | 30 | 80 |
| Avena fatua | 100 | 50 | 70 | 90 |
| ALOMY | 50 | 95 | 90 | 100 |
| Alopecurus | 100 | 99 | 99 | 100 |
| myosuroides | | | | |
| APESV | 50 | 100 | 95 | 99 |
| Apera spica-venti | 100 | 100 | 100 | 100 |
| LOLMU | 50 | 30 | 20 | 40 |
| Lolium multiflorum | 100 | 50 | 50 | 80 |
| AMARE | 50 | 100 | 100 | 100 |
| Amaranthus retroflexus | 100 | 100 | 100 | 100 |
| GALAP | 50 | 90 | 95 | 95 |
| Galium aparine | 100 | 95 | 95 | 95 |
| GLXMA | 50 | 20 | 10 | 10 |
| Glycine max (soja) | 100 | 40 | 10 | 10 |

### Process B (Solvent Removal Induced Encapsulation)

In a second embodiment the encapsulated actives are produced by colloidal encapsulation, which provides excellent control of particle and phase properties.

### General Synthesis

In a typical synthesis in a first step the active was fully dissolved in a suitable solvent (cf. Table 12 “solution A”). The same solvent was used to fully dissolve the polymer (cf. Table 12 “solution B”). The organic solutions were combined and then added to the aqueous phase (cf. Table 12 “solution C”) containing a stabilizer that allows for emulsification.

Subsequent high shear mixing yielded the intermediate emulsion. Briefly, dispersing of the “oil phase” was carried out using rotor-stator high shear mixing (Ultra-Turrax, SN25-25F) at 10000 RPM for 300 sec, however other methods for emulsification known to the skilled artisan may be used as well.

The organic solvent of the resulting mixture was fully removed under vacuum, yielding a white dispersion. Further concentration of the dispersion, i.e. removal of water, was carried out using a centrifugation-decanting step, yielding the final formulations B-1 to B-5 as described in Table 13.

In order to increase the electrolyte content of Example B-5, the solution obtained after concentrating was mixed 1:1 (v:v) with a 4 mol/L aqueous NaCl solution, obtaining example B-6.

Suitable solvents are water miscible organic solvents, preferably water miscible polar solvents, more preferred water miscible aprotic polar solvents, even more preferred selected from the group consisting of chloroform, dichloromethane, ethyl acetate and THF (tetrahydrofuran), and most preferred chloroform and dichloromethane.

Suitable polymers are any homo- or copolymers that are soluble in an organic solvent and allow formation of an emulsion in water, preferably the polymers are selected from the group comprising pure D or L lactates, lactide-co-caprolactone, lactide-co-glycolide; polyesters, polyamides, polyacrylates, polystyrenes, polyvinyls, more preferred the polymer is selected from the group comprising poly(lactic acid) (PLA) either free acid or ester terminated, poly(caprolactone) and poly(vinylacetate), and most preferred the polymer is PLA.

The Mw of the polymer is preferably between 1 to 1000 kDa, more preferred between 5 and 200 kDa, even more preferred between 10 and 100 kDa and most preferred between 15 and 30 kDa.

The polymer to active ratio, independent from shell thickness, may be adjusted to tailor the release profile, but is preferably between 0.1 to 1 and 30 to 1, more preferred between 0.5 to 1 and 20:1, and even more preferred between 1:1 to 10:1.

According to the invention, the biological control agent may be employed or used in any physiologic state such as active or dormant.

Preferred active compounds are selected from the group comprising SDH-Inhibitors, nAChR-Agonists (including neonicotinoides), chlorotica including PDS inhibitors (HRAC F1) and HPPD inhibitors (HRAC F2) and thiadiazole carboxamides/host defence inducers.

More preferred active compounds for encapsulation according to the invention are selected from the group comprising Fluopyram, Flupyradifurone, Diflufenican, Isoxaflutole, Imidacloprid and Isotianil.

Most preferred active compounds Fluopyram, Diflufenican, Isoxaflutole.

Suitable stabilisers are oil in water stabilizers known in the art, preferably gelantine, ethoxylated sorbitan fattyacid esters (e.g. Tween) and NaCl-solution.

The particle size of the produced capsules is preferably between d₅₀=1-200 μm (micrometer), more preferred between d₅₀=1-50 μm (micrometer). For foliar applications the particle size is preferably between d₅₀=1-20 μm (micrometer).

### EXAMPLES

All preparations are summarized in Table 12. In a typical synthesis the active was first fully dissolved in a suitable solvent, see solution A, Table 12. The same solvent was used to fully dissolve the polymer, see solution B, Table 12. Polymer to active ratio may be adjusted to tailor the release profile. Both organic solutions, solution A+B, were combined and then added to the aqueous phase, ref. solution C. Subsequent high shear mixing yielded the intermediate emulsion. Briefly, dispersing of the “oil phase” was carried out using rotor-stator high shear mixing (Ultra-Turrax, SN25-25F) at 10000 RPM for 300 sec. The organic solvent of the resulting mixture was fully removed under vacuum, yielding a white dispersion. Further concentration of the dispersion, i.e. removal of water, may be carried out using a centrifugation-decanting step, yielding, the final formulations B1-5 and B7-8 as described in Table 13. In order to increase the electrolyte content of Example B-5, the solution obtained after concentrating was mixed 1:1 (v:v) with a 4 mol/L aqueous NaCl solution, obtaining example B-6.

TABLE 12
Detailed composition of formulations according to process B

| | manufacturing/stocks | | | |
|---|---|---|---|---|
| | | | stabilizer in aqeous | Increased ion |
| | FLU solution | polymer solution | solution | strength |
| | solution A | solution B | solution C | solution D |
| Example | 6.1 g FLU solution | 6.1 g poly(lactic acid)* | 80.0 g Gelatine | no |
| B-1 | (13.3% FLU w/w | solution | solution | |
| | in chloroform) | (13.3% w/w in chloroform) | (0.5% w/w in water) | |
| Example | 6.1 g FLU solution | 6.1 g poly(lactic acid)* | 80.0 g | no |
| B-2 | (13.3% FLU w/w | solution (13.3% w/w in | Gelatine/Tween 20 | |
| | in chloroform) | chloroform) | solution | |
| | | | (0.5%/0.1% w/w in | |
| | | | water) | |
| Example | 6.0 g FLU solution | 60.0 g poly(lactic acid)* | 800 g Gelatine | no |
| B-3 | (13.3% FLU w/w | solution (13.3% w/w in | solution | |
| | in chloroform) | chloroform) | (0.5% w/w in water) | |
| Example | 6.0 g FLU solution | 60.0 g poly(lactic acid)* | 800.0 g | no |
| B-4 | (13.3% FLU w/w | solution (13.3% w/w in | Gelatine/Tween 20 | |
| | in chloroform) | chloroform) | solution | |
| | | | (0.5%/0.1% w/w in | |
| | | | water) | |
| Example | 5.5 g FLU solution | 55.0 g poly(lactic acid)* | 800 g Gelatine/NaCl | no |
| B-5 | (15% FLU w/w in | solution (15% w/w in | solution | |
| | dichloromethane) | dichloromethane) | (0.5% w/w/0.1 mol | |
| | | | NaCl/L) in water | |
| Example | 5.5 g FLU solution | 55.0 g poly(lactic acid)* | 800 g Gelatine/NaCl | 32.0 g NaCl |
| B-6 | (15% FLU w/w in | solution | solution | solution |
| | dichloromethane) | (15% w/w in | (0.5% w/w /0.1 mol | (4.0 mol/L in |
| | | dichloromethane) | NaCl/L) in water | water) |
| Example | 6.1 g FLU solution | 114 g poly(lactic acid)* | 100 g Gelatine | no |
| B 7 | (20% FLU w/w in | solution | solution | |
| | dichloromethane) | (10% w/w in | (2% w/w in water) | |
| | | dichloromethane) | | |
| Example | 6.2 g FLU solution | 114 g poly(lactic acid)* | 100 g Gelatine | no |
| B-8 | (20% FLU w/w in | solution | solution | |
| | chloroform) | (10% w/w in | (1% w/w in water) | |
| | | dichloromethane) | | |
| Example | 6.0 g IFT solution | 110 g poly(lactic acid)* | 800 g Gelatine | no |
| B-9 | (20% IFT w/w in | solution | solution | |
| | dichloromethane) | (10% w/w in | (0.5% w/w in 0.1M | |
| | | dichloromethane) | aqueous NaCl) | |
| Example | 6.0 g IFT solution | 110 g poly(lactic acid)* | 50 g Gelatine | no |
| B-10 | (20% IFT w/w in | solution | solution | |
| | dichloromethane) | (10% w/w in | (2% w/w in 0.1M | |
| | | dichloromethane) | aqueous NaCl) | |
| Example | 117 g IFT-PLA solution | | 100 g Gelatine | no |
| B-11 | (3% w/w IFT and 10% w/w polylactic acid in | | solution | |
| | dichloromethane) | | (1% w/w in 0.1M | |
| | | | aqueous NaCl) | |
| Example | 18.0 g IFT solution | 114 g poly(lactic acid)* | 800 g Gelatine | no |
| B-12 | (20% IFT w/w in | solution | solution | |
| | dichloromethane) | (10% w/w in | (1% w/w in 0.1M | |
| | | dichloromethane) | aqueous NaCl) | |

| | | | |
|---|---|---|---|
| Example | 113 g DFF-PLA solution | 100 g Gelatine | no |
| B-13 | (1% w/w DFF and 10% w/w polylactic acid in | solution | |
| | dichloromethane) | (2% w/w in 0.1M | |
| | | aqueous NaCl) | |
| Example | 113 g DFF-PLA solution | 50 g Gelatine | no |
| B-14 | (1% w/w DFF and 10% w/w polylactic acid in | solution | |
| | dichloromethane) | (2% w/w in 0.1M | |
| | | aqueous NaCl) | |

*PLA R 203 H-acid terminated; Resomer ®

TABLE 13
Final composition of formulations obtained according to process B after full work-up, fluopyram
concetration was measured using HPLC. All other concentrations were calculated based on the
employed synthesis conditions.

| | composition | | | | | | |
|---|---|---|---|---|---|---|---|
| | composition of formulation after full workup (incl. concentrating) in % w/w | | | | | | |
| | of formulation | | | | | | |
| | PLA | active | Gelatine | Tween 20 | water | NaCL | SUM |
| Example B-1 | 9.6 | 9.6 FLU | 0.40 | 0 | 80 | 0 | 100 |
| Example B-2 | 5.5 | 5.5 FLU | 0.44 | 0.09 | 89 | 0 | 100 |
| Example B-3 | 2.9 | 28.8 FLU | 0.34 | 0 | 68 | 0 | 100 |
| Example B-4 | 2.2 | 22.0 FLU | 0.38 | 0.08 | 75 | 0 | 100 |
| Example B-5 | 2.3 | 23.4 FLU | 0.37 | 0 | 73 | 0.04 | 100 |
| Example B-6 | 2.5 | 25.2 FLU | 0.32 | 0 | 65 | 0.79 | 100 |
| Example B-7 | 3.3 | 31.1 FLU | 2.7 | 0 | 63 | 0 | 100 |
| Example B-8 | 3.4 | 31.1 FLU | 2.7 | 0 | 63 | 0 | 100 |
| Example B-9 | 3.5 | 32.1 IFT | 0.32 | 0 | 64 | 0.04 | 100 |
| Example B-10 | 2.6 | 23.8 IFT | 1.44 | 0 | 72 | 0.04 | 100 |
| Example B-11 | 27.7 | 8.3 IFT | 0.32 | 0 | 63 | 0.04 | 100 |
| Example B-12 | 6.3 | 20.0 IFT | 0.73 | 0 | 73 | 0.04 | 100 |
| Example B-13 | 19.0 | 1.9 DFF | 2.00 | 0 | 77 | 0.04 | 100 |
| Example B-14 | 19.0 | 1.9 DFF | 2.00 | 0 | 77 | 0.04 | 100 |

### Seed Treatments and Biology Tests for Formulations Obtained According to Process B

Samples were supplied as aqueous suspensions and were applied to soybean seeds at a rate of 0.075 mg/seed using 100-250 g of seed in a small or medium sized Hege bowl seed treater.

TABLE 14
Summary on greenhouse results obtained for soy treated with formulations obtained
according to process B. The Halo-cffcct on soy beans treated with controlled release
formulations obtained according to process B was signifantly reduced for all examples.
Moreover, for B-5 Halo was almost eliminated proving the high efficacy of the
controlledr elease formulation in contast to the standard treatement with fluopyram.

| | | | | | | Results |
|---|---|---|---|---|---|---|
| | | Cotyledon Leaf Area (cm²) | | | | Plant |
| Entry | Sample ID | Total | Healthy | Halo | % Halo | Height (cm) |
| UTC | Untreated | 1.8112 | 1.8109 | 0.0003 | 0.02 | 8.09 |
| FLU-ref | FLU FS 600 | 1.2694 | 1.1132 | 0.1563 | 12.31 | 8.12 |
| B-1 | CR-formulation | 1.4757 | 1.3264 | 0.1493 | 10.12 | 8.03 |
| B-2 | CR-formulation | 1.4832 | 1.3528 | 0.1305 | 8.80 | 8.40 |
| B-5 | CR-formulation | 1.6748 | 1.6419 | 0.0329 | 1.96 | 9.06 |
| B-6 | CR-formulation | 1.5532 | 1.4532 | 0.1000 | 6.44 | 8.44 |

TABLE 15
Proved efficacy of controlled release formulations obtained
according to process B, root lesions nematode bioassay
and sudden death syndrome bioassay. In addition to the
high degree of Halo elimination for controlled release
formulation B-5, this formulation was furthermore
tested to have similar efficacy agains Nematodes
(Root Lesion count) and an improved efficacy
against fungicidal disease sudden death syndrome.

| | | | SDS |
|---|---|---|---|
| Entry | Sample ID | RootLesionCount | rating |
| UTC | Untreated | 167 | 4.0 |
| FLU-ref | FLU FS 600 | 37 | 2.5 |
| B-5 | CR-formulation | 47 | 1.0 |

### Biology Tests in Soil Drench Applications for Formulations Obtained According to Process B

Samples were supplied as aqueous suspensions and were applied at 8, 10, 20 mg a.i. per cucumber plant by applying 60 mL soil drenches. Plant health (damage) was recorded 3/4/5/7/10 and 14 days after application by visual inspection of leafs (% leaf area with chlorosis+necrosis) and shoot fresh weight measurement. Both samples B-7 and B-8 were tested versus untreated control cucumber plants (UTC) and a non-controlled release fluopyram (Velum® SC400).

TABLE 16
Proved efficacy of controlled release formulations obtained according to process B, % damaged
leaf area was significantly reduced and for early time points fully eliminated, i.e. comparable to
the untreated control (UTC). The significant improved is evident accros all dose rates, i.e. 8, 10,
20 mg fluopyram per plant. Results represent average of triplicate analysis. Number in bracket
indicates application rate in mg active/plant

| Entry | Sample ID | 3d | 4d | 5d | 7d | 10d | 14d |
|---|---|---|---|---|---|---|---|
| UTC | Untreated | 1% (0) | 2% (0) | 2% (0) | 2% (0) | 2% (0) | 2% (0) |
| FLU-ref | FLU Velum ® | 20% (20) | 27% (20) | 32% (20) | 33% (20) | 43% (20) | 43% (20) |
| | SC 400 | 6% (10) | 11% (10) | 17% (10) | 23% (10) | 37% (10) | 45% (10) |
| | | 10% (8) | 15% (8) | 18% (8) | 23% (8) | 38% (8) | 40% (8) |
| B-7 | CR-formulation | 1% (20) | 5% (20) | 5% (20) | 7% (20) | 13% (20) | 18% (20) |
| | | 1% (10) | 2% (10) | 2% (10) | 2% (10) | 3% (10) | 3% (10) |
| | | 1% (8) | 3% (8) | 3% (8) | 3% (8) | 4% (8) | 4% (8) |
| B-8 | CR-formulation | 0% (20) | 1% (20) | 2% (20) | 3% (20) | 5% (20) | 5% (20) |
| | | 0% (10) | 1% (10) | 1% (10) | 2% (10) | 3% (10) | 3% (10) |
| | | 0% (8) | 1% (8) | 1% (8) | 2% (8) | 2% (8) | 2% (8) |

TABLE 17
Controlled release isoxallutole herbicide applied on maize proves the superiority
of the controlled release treatments, “plant damage” (percent).

| | | non-CR | | | | |
|---|---|---|---|---|---|---|
| | application | reference | | | | |
| | rate [g | Balance | | | | |
| | IFT/ha] | Pro | B-9 | B-10 | B-11 | B-12 |
| AVEFA | 50 | 95 | 80 | 70 | 60 | 60 |
| Avena fatua | 100 | 99 | 90 | 90 | 95 | 85 |
| ECHCG | 50 | 100 | 90 | 70 | 90 | 95 |
| Echinochloa crus-galli | 100 | 100 | 95 | 95 | 100 | 100 |
| DIGSA | 50 | 100 | 90 | 90 | 80 | 100 |
| Digitaria sanguinalis | 100 | 100 | 100 | 99 | 100 | 100 |
| SETVI | 50 | 100 | 90 | 90 | 80 | 90 |
| Setaria viridis | 100 | 100 | 95 | 95 | 100 | 95 |
| GALAP | 50 | 95 | 80 | 80 | 80 | 70 |
| Galium aparine | 100 | 98 | 100 | 95 | 95 | 80 |
| AMARE | 50 | 100 | 100 | 80 | 100 | 100 |
| Amaranthus | 100 | 100 | 100 | 100 | 100 | 100 |
| retroflexus | | | | | | |
| ZEAMA | 50 | 40 | 20 | 20 | 10 | 20 |
| Zea mays (maize) | 100 | 60 | 40 | 30 | 80 | 30 |

TABLE 18
Controlled release formulations of herbicide diflufenican
applied on soja proves the superiority of the controlled
release treatments, “plant damage” (percent).

| | application | non-CR | | |
|---|---|---|---|---|
| | rate [g | reference | | |
| | DFF/ha] | Brodal ® | B-13 | B-14 |
| AVEFA | 50 | 30 | 50 | 50 |
| Avena fatua | 100 | 70 | 90 | 90 |
| ALOMY | 50 | 100 | 99 | 100 |
| Alopecurus | 100 | 100 | 100 | 100 |
| myosuroides | | | | |
| APESV | 50 | 99 | 99 | 100 |
| Apera spica-venti | 100 | 100 | 100 | 100 |
| LOLMU | 50 | 70 | 70 | 90 |
| Lolium multiflorum | 100 | 95 | 99 | 99 |
| AMARE | 50 | 100 | 100 | 100 |
| Amaranthus | 100 | 100 | 100 | 100 |
| retroflexus | | | | |
| GALAP | 50 | 90 | 90 | 99 |
| Galium aparine | 100 | 95 | 99 | 99 |
| GLXMA | 50 | 30 | 20 | 10 |
| Glycine max (soja) | 100 | 40 | 20 | 30 |

### Process C (Active Coating Using a Spouted Bed)

In a third embodiment the encapsulated actives are produced by spray coating in a spouted bed.

### General Synthesis

Preparation for spouted bed spray coating: Stabilization of active particles

Very fine actives may need an additional stabilization to obtain a stable fluidized bed.

Therefore, if necessary 18.0 g stabilizer (e.g. Aerosil® 150 or Aerosil® R974) may be intimately mixed with 600 g of active using a Retsch Grindomix GM 300 blade mill at 5000 rpm for 3 minutes.

In a preferred embodiment the stabilizer is added and the particles are stabilized.

### Spray Coating in Spouted Bed

600 g of the stabilized active were loaded into a Glatt ProCell LabSystem equipped with a ProCell 5 spouted bed. Spray solutions were either 5% or 10% polymer in a suitable solvent, for relevant process parameters see Table 19.

Spray time (time of coating) was adjusted for obtaining targeted coating thickness.

Spray coating was conducted under inert gas atmosphere using a gas flow of preferably 10 to 150 m³/hour, more preferred 45 to 125 m³/hour, even more preferred 80 to 110 m³/hour, and most preferred 90 m/hour.

Nebulizer pressure was always set to preferably 0.5 to 4.5 bar, more preferred to 1.5 to 3.5 bar, even more preferred to 2.0 to 3.0 bar, and most preferred to 2.5 bar.

Encapsulation efficiency EE was determined to be preferably >90% for polyvinyl acetate encapsulated FLU, 60-90% for polycaprolactone and 290% for cellulose acetate.

Transferring into SC-Type Formulation

285 mg rheological modifier and 3.7 g dispersing agent were dissolved in 66.0 g water. 5.0 g of said mixture were used to disperse 50 mg of the dry encapsulated fluopyram prepared in the spouted bed. Homogenization was carried out using a suitable homogenizer, e.g. a Laboratory-Vortex at 1000 rpm for 30-60 sec.

Suitable rheological modifiers by way of example are organic or inorganic rheological modifiers, preferably selected from the group comprising polysaccharides including xanthan gum, guar gum and hydroxyethyl cellulose. Examples are Kelzan®, Rhodopol® G and 23, Satiaxane® CX911 and Natrosol®250 range, clays including montmorillonite, bentonite, sepeolite, attapulgite, laponite, hectorite. Examples are Veegum® R, Van Gel® B, Bentone® CT, HC, EW, Pangel® M100, M200, M300, S, M, W, Attagel® 50, Laponite® RD, and fumed and precipitated silica, examples are Aerosil® 200, Siponat® 22.

More preferred are polysaccharides including xanthan gum, guar gum and hydroxyethyl cellulose and most preferred is xanthan gum.

Suitable non-ionic dispersing agents are all substances of this type which can customarily be employed in agrochemical agents. Preferably, polyethylene oxide-polypropylene oxide block copolymers, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Suitable anionic dispersing agents are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid, polycarboxylic acid-co-polymers and their common salts.

Preferably the dispersing agent is a non-ionic dispersing agent, more preferred from the group of copolymers of (meth)acrylic acid and (meth)acrylic acid esters.

Suitable inert gases are selected from the group of nitrogen, helium, neon, argon, krypton and xenon, preferably nitrogen, helium and neon, and most preferred nitrogen.

Suitable dry particle stabilizers ensuring the integrity of the fluid bed are preferably anti-caking agents such as silica and silicates, talcum, bentonites and phosphates, more preferred the stabilizer is selected from the group of fumed silicas.

Suitable solvents are organic solvents, preferably polar solvents, more preferred aprotic polar solvents, even more preferred selected from the group consisting of chloroform, dichloromethane, ethylacetate, methylacetate, acetone, MiBK (Methyl-iso-butylketone), Diethylether and THF (tetrahydrofurane), and most preferred ethyl acetate, acetone and THF.

Suitable polymers for encapsulation are any homo- or copolymers that are soluble in an organic solvent, preferably the polymers are selected from the group comprising polyvinylic, polyesters, polyurethanes, polyvinylacetates, polylactones, polyethers, polysaccarides, including polyvinyl acetates, polycaprolactone and cellulose acetates as well as PLA (poly lactic acid).

In an alternative embodiment the coating process is based on waterborne polymers, preferably dissolved polymers, even more preferred dispersed polymers. Most preferred polymers are comprised of the group of VAE (vinyl acetate ethylene copolymers), polyacrylates, polystyrenes, polyvinylic, polycaprolactones, polyesters and polyurethanes, polysaccarides, (all as homo or copolymers)

The Mw of the polymer is preferably between 1 to 1000 kDa, more preferred between 5 and 200 kDa, even more preferred between 10 and 100 kD.

The polymer to active ratio, independent from shell thickness, may be adjusted to tailor the release profile, but is preferably between 0.001 to 1 and 1 to 1, more preferred between 0.01 to 1 and 0.5:1.0, and even more preferred between 0.6:1 to 0.4:1.0.

According to the invention, the biological control agent may be employed or used in any physiologic state such as active or dormant.

Preferred active compounds are selected from the group comprising SDH-Inhibitors, nAChR-Agonists (including neonicotinoides), chlorotica including PDS inhibitors (HRAC F1) and HPPD inhibitors (HRAC F2) and thiadiazole carboxamides/host defence inducers.

Other preferred active compounds are selected from pesticides causing a phytotoxicity side effect on agricultural crops.

More preferred active compounds for encapsulation according to the invention are selected from the group comprising Fluopyram, Flupyradifurone, Diflufenican, Isoxaflutole, Imidacloprid and Isotianil.

Most preferred active compounds for encapsulation according to the invention are selected from the group comprising, Fluopyram. Diflufenican, Isoxaflutole

The particle size of the produced capsules is preferably between d₅₀=1-200 μm (micrometer), more preferred between d₅₀=1-50 μm (micrometer). For foliar applications the particle size is preferably between d₅₀=1-20 μm (micrometer).

### Examples C-1 to C-11

### Preparation for Spouted Bed Spray Coating: Stabilization of Active Particles

Very fine actives may need an additional stabilization to obtain a stable fluidized bed. 18.0 g Aerosil® 150 was intimately mixed with 600 g fluopyram or 600 g diflufenican using a Retsch Grindomix GM 300 blade mill at 5000 rpm for 3 minutes. The particle size of the as prepared Aerosil® 150-fluopyram-mixture was determined to be d.10=2 μm; d.50=8 μm; d.90=24 μm. The particle size of the as prepared Aerosil® 150-diflufenican-mixture was determined to be d.10=0.8 μm; d.50=1.4 μm; d.90=5 μm.

### Spray Coating in Spouted Bed

600 g of the Aerosil® 150 stabilized fluopyram or 600 g of the Aerosil® 150 stabilized diflufenican were loaded into a Glatt ProCell LabSystem equipped with a ProCell 5 spouted bed. Spray solutions were either 5% or 10% polymer in a suitable solvent, for relevant process parameters, cf.

Table 19. Spray time (time of coating) was adjusted for obtaining targeted coating thickness. Spray coating was conducted under nitrogen atmosphere using a gas flow of 90 m³/hour. Nebulizer pressure was always set to 2.5 bar. Encapsulation efficiency EE was determined to be >90% for polyvinyl acetate encapsulated FLU, 60-90% for polycaprolactone and ≥90% for cellulose acetate.

Transferring into SC-Type Formulation C-1 to C-11

285 mg Kelzan S and 3.7 g ATLOX 4913 were dissolved in 66.0 g water. 5.0 g of before prepared mixture were used to disperse 50 mg of the dry encapsulated fluopyram. Homogenization was carried out using a Laboratory-Vortex at 1000 rpm for 30-60 sec.

Transferring into SC-Type Formulation C-12 to C-16

2.0 g Kelzan S, 8.8 g Geropon T36, 4.40 g Morwet D425, 0.32 g Acticide SPX and 0.72 g Proxel GXL were dissolved in 348 g water. 27 g of before prepared mixture were used to disperse 3.0 g of the dry encapsulated Diflufenican. Homogenization was carried out using a Laboratory-Vortex at 1000 rpm for 30-60 sec.

TABLE 19
Detailed composition of formulations according to process C

| | synthesis/product coposition | | | | |
|---|---|---|---|---|---|
| | | | polymer | | |
| | | | concentration | | |
| | | | in spray | | |
| | | | solution | process | calculated |
| entry | polymer | solvent | [% m/m] | parameters | coating(polymer):active ratio |
| Example C-1 | polyvinyl acetate | ethyl acetate | 10 | T(in) = 50° C. | 0.12 |
| | | | | v(feed) = 13 | |
| | | | | g/min | |
| Example C-2 | polyvinyl acetate | ethyl acetate | 10 | T(in) = 50° C. | 0.24 |
| | | | | v(feed) = 13 | |
| | | | | g/min | |
| Example C-3 | polyvinyl acetate | ethyl acetate | 10 | T(in) = 50° C. | 0.36 |
| | | | | v(feed) = 13 | |
| | | | | g/min | |
| Example C-4 | polyvinyl acetate | ethyl acetate | 10 | T(in) = 50° C. | 0.40 |
| | | | | v(feed) = 13 | |
| | | | | g/min | |
| Example C-5 | polycaprolactone | ethyl acetate | 5 | T(in) = 50° C. | 0.06 |
| | | | | v(feed) = 13 | |
| | | | | g/min | |
| Example C-6 | polycaprolactone | ethyl acetate | 5 | T(in) = 50° C. | 0.12 |
| | | | | v(feed) = 13 | |
| | | | | g/min | |
| Example C-7 | polycaprolactone | ethyl acetate | 5 | T(in) = 50° C. | 0.16 |
| | | | | v(feed) = 13 | |
| | | | | g/min | |
| Example C-8 | cellulose acetate | acetone | 10 | T(in) = 45° C. | 0.17 |
| | | | | v(feed) = 16 | |
| | | | | g/min | |
| Example C-9 | cellulose acetate | acetone | 10 | T(in) = 45° C. | 0.23 |
| | | | | v(feed) = 16 | |
| | | | | g/min | |
| Example C-10 | cellulose acetate | acetone | 10 | T(in) = 45° C. | 0.33 |
| | | | | v(feed) = 16 | |
| | | | | g/min | |
| Example C-11 | cellulose acetate | acetone | 10 | T(in) = 45° C. | 0.39 |
| | | | | v(feed) = 16 | |
| | | | | g/min | |
| Example C-12 | cellulose acetate | acetone | 5 | T(in) = 60° C. | 0.04 |
| | | | | v(feed) = 15 | |
| | | | | g/min | |
| Example C-13 | cellulose acetate | acetone | 5 | T(in) = 60° C. | 0.08 |
| | | | | v(feed) = 15 | |
| | | | | g/min | |
| Example C-14 | cellulose acetate | acetone | 5 | T(in) = 60° C. | 0.12 |
| | | | | v(feed) = 15 | |
| | | | | g/min | |
| Example C-15 | cellulose acetate | acetone | 5 | T(in) = 60° C. | 0.16 |
| | | | | v(feed) = 15 | |
| | | | | g/min | |
| Example C-16 | cellulose acetate | acetone | 5 | T(in) = 60° C. | 0.19 |
| | | | | v(feed) = 15 | |
| | | | | g/min | |

### Seed Treatments and Biology Tests for Formulations Obtained According to Process C

Formulation of the dry particles into concentrated suspensions was done according to the mixture ratios described in

Table 20 Subsequently, the aqueous suspensions were applied to soybean seeds at a rate of 0.075 mg/seed using 100-250 g of seed in a small or medium sized Hege bowl seed treater.

TABLE 20
Formulation of dry encapsulated fluopyram obtained according to process
C into suspension concentrates

| | | | Component Mass (g) | | | |
|---|---|---|---|---|---|---|
| | | FLU w/w% | | Atlox | Xanthan | |
| Entry | Polymer | (Powder) | FLU Powder | 4913 | Gum (2%) | Water |
| C-1 | PVA | 0.87 | 2.53 | 1.00 | 0.75 | 5.72 |
| C-2 | PVA | 0.79 | 2.79 | 1.00 | 0.75 | 5.46 |
| C-3 | PVA | 0.72 | 3.05 | 1.00 | 0.75 | 5.20 |
| C-4 | PVA | 0.70 | 3.15 | 1.00 | 0.75 | 5.10 |
| C-5 | PCL | 0.91 | 2.41 | 1.00 | 0.75 | 5.84 |
| C-6 | PCL | 0.87 | 2.53 | 1.00 | 0.75 | 5.72 |
| C-7 | PCL | 0.84 | 2.61 | 1.00 | 0.75 | 5.64 |
| C-8 | CA | 0.83 | 2.64 | 1.00 | 0.75 | 5.61 |
| C-9 | CA | 0.79 | 2.78 | 1.00 | 0.75 | 5.47 |
| C-10 | CA | 0.73 | 3.00 | 1.00 | 0.75 | 5.25 |
| C-11 | CA | 0.71 | 3.12 | 1.00 | 0.75 | 5.13 |

TABLE 21
Summary on greenhouse results obtained for soy treated with formulations obtained according to
process C. A clear trend of halo reduction on treated soybeans is seen with increasing polymer
shell, from C-l to C-4 the observed halo-effcct is constantly reduced with C-4 allowing an almost
complete elimination of the halo. A likewise trend is seen for C-8 to C-11, with C-10 and C-11
exhibiting almost not measurable halo effect. For polycaprolactone coated fluopyram, i.e. C-5 to
C-7 the observed halo effect was similar to the non-control led release reference of fluopyram.

| | | FLU | Cotyledon Leaf Area (cm²) | | | |
|---|---|---|---|---|---|---|
| Entry | Detail | w/w% | Total | Healthy | Halo | % Halo |
| UTC | Untreated | na | 1.8002 | 1.7993 | 0.0009 | 0.05 |
| FLU-ref | FLU FS 600 | na | 1.2860 | 1.1350 | 0.1510 | 11.74 |
| C-1 | PVA | 88 | 1.3004 | 1.1365 | 0.1639 | 12.60 |
| C-2 | PVA | 77 | 1.5938 | 1.5036 | 0.0902 | 5.66 |
| C-3 | PVA | 66 | 1.8548 | 1.8445 | 0.0103 | 0.56 |
| C-4 | PVA | 61 | 1.8339 | 1.8318 | 0.0021 | 0.12 |
| C-5 | PCL | 94 | 1.2215 | 1.0632 | 0.1600 | 13.10 |
| C-6 | PCL | 89 | 1.3140 | 1.1716 | 0.1424 | 10.84 |
| C-7 | PCL | 85 | 1.3339 | 1.1892 | 0.1447 | 10.85 |
| C-8 | CA | 84 | 1.4754 | 1.3583 | 0.1184 | 8.03 |
| C-9 | CA | 77 | 1.6637 | 1.6414 | 0.0223 | 1.34 |
| C-10 | CA | 67 | 1.7828 | 1.7816 | 0.0013 | 0.07 |
| C-11 | CA | 63 | 1.9965 | 1.9950 | 0.0014 | 0.07 |

TABLE 22
Plant height and SDS rating for Glatt microencapsulated samples

| Entry | Sample ID | Plant Height | SDS Rating |
|---|---|---|---|
| UTC | Untreated | 4.54 | 4.0 |
| FLU-ref | FLU FS 600 | 3.55 | 2.5 |
| C-4 | GCIDA020-4-4 | 4.10 | 2.5 |
| C-11 | GCIDA020-6-4 | 4.91 | 4.0 |

### Biology Tests in Soil Drench Applications for Formulations Obtained According to Process C

Samples were supplied as aqueous suspensions as described in Table 19 and were applied at 8, 10, 20 mg a.i. per cucumber plant by applying 60 mL soil drenches. Plant health (damage) was examined 3/4/5/7/10 and 14 days after application by visual inspection of leafs (% leaf area with chlorosis+necrosis) and shoot fresh weight measurement. Samples C-4 and C-9 to C-11 were tested versus untreated control cucumber plants (UTC) and a non-controlled release fluopyram (Velum® SC400), cf Table 8.

For samples C-9 to C-11 the degree of leaf damage correlates with polymer shell thickness. In particular towards later inspection times, e.g. for 10d & 14d this trend becomes clearly pronounced as the cucumber plant was exposed to active for a longer time and the shells becoming more and more permeable in the order from thin to thick polymer coating (cellulose acetate to fluopyram ratio was 0.23(C-9), 0.33(C-10), 0.39(C-11)) cf. Table 19

TABLE 23
Proved efficacy of controlled release formulations obtained according to process C, % damaged
leaf area was in all cases significantly reduced and in the majority of cases fully eliminated, i.e.
comparable to the untreated control (UTC). The significant improved is evident accros all dose
rates, i.e. 8, 10, 20 mg fluopyram per plant. Results represent average of triplicate analysis.
Number in bracket indicates application rate in mg active/plant

| Entry | Sample ID | 3d | 4d | 5d | 7d | 10d | 14d |
|---|---|---|---|---|---|---|---|
| UTC | Untreated | 1% (0) | 2% (0) | 2% (0) | 2% (0) | 2% (0) | 2% (0) |
| FLU-ref | FLU Velum ® | 20% (20) | 27% (20) | 32% (20) | 33% (20) | 43% (20) | 43% (20) |
| | SC 400 | 6% (10) | 11% (10) | 17% (10) | 23% (10) | 37% (10) | 45% (10) |
| | | 10% (8) | 15% (8) | 18% (8) | 23% (8) | 38% (8) | 40% (8) |
| C-4 | CR-formulation | 0% (20) | n.d. | n.d. | 0% (20) | 1% (20) | 1% (20) |
| | | 0% (10) | | | 0% (10) | 0% (10) | 2% (10) |
| | | 0% (8) | | | 0% (8) | 1% (8) | 1% (8) |
| C-9 | CR-formulation | 1% (20) | 2% (20) | 2% (20) | 3% (20) | 6% (20) | 9% (20) |
| | | 1% (10) | 2% (10) | 2% (10) | 2% (10) | 4% (10) | 4% (10) |
| | | 1% (8) | 2% (8) | 2% (8) | 2% (8) | 4% (8) | 5% (8) |
| C-10 | CR-formulation | 1% (20) | 2% (20) | 2% (20) | 2% (20) | 5% (20) | 5% (20) |
| | | 1% (10) | 1% (10) | 1% (10) | 1% (10) | 3% (10) | 4% (10) |
| | | 0% (8) | 0% (8) | 1% (8) | 1% (8) | 4% (8) | 4% (8) |
| C-11 | CR-formulation | 0% (20) | n.d. | n.d. | 0% (20) | 1% (20) | 3% (20) |
| | | 0% (10) | | | 0% (10) | 0% (10) | l% (10) |
| | | 0% (8) | | | 0% (8) | 0% (8) | l% (8) |

TABLE 24
Controlled release formulations of herbicide diflufenican applied on soja proves
the superiority of the controlled release treatments, “plant damage” (percent).

| | | non-CR | | | | | |
|---|---|---|---|---|---|---|---|
| | application | reference | | | | | |
| | rate [g | Balance | | | | | |
| | IFT/ha] | Pro | C-12 | C-13 | C-14 | C-15 | C-16 |
| AVEFA | 50 | 30 | 10 | 10 | 10 | 10 | 10 |
| Avena fatua | 100 | 70 | 30 | 30 | 20 | 20 | 20 |
| ALOMY | 50 | 100 | 30 | 90 | 50 | 30 | 10 |
| Alopecurus | 100 | 100 | 100 | 100 | 70 | 90 | 20 |
| myosuroides | | | | | | | |
| APESV | 50 | 99 | 10 | 20 | 10 | 10 | 10 |
| Apera spica-venti | 100 | 100 | 99 | 95 | 40 | 40 | 20 |
| LOLMU | 50 | 70 | 10 | 20 | 10 | 10 | 10 |
| Loliurn | 100 | 95 | 95 | 70 | 50 | 40 | 20 |
| multiflorum | | | | | | | |
| AMARE | 50 | 100 | 100 | 100 | 100 | 100 | 50 |
| Amaranthus | 100 | 100 | 100 | 100 | 100 | 100 | 70 |
| retroflexus | | | | | | | |
| GALAP | 50 | 90 | 20 | 50 | 30 | 10 | 10 |
| Galium aparine | 100 | 95 | 95 | 90 | 90 | 70 | 20 |
| GLXMA | 50 | 30 | 10 | 10 | 10 | 5 | 5 |
| Glycine max | 100 | 40 | 10 | 10 | 20 | 10 | 20 |
| (soja) | | | | | | | |

TABLE 25
Materials used for this patent:

| Tradename/trivial | Company (Exemplary if | | |
|---|---|---|---|
| name | there is no Tradename) | Description | CAS-No. |
| Atlox 4915 | Croda | Amphoteric polymeric | n/a |
| | | alkoxylated ethylethanolamine | |
| | | ester w/ free carboxylic acids | |
| Synprolam | Croda | unknown | n/a |
| Eudragit RS30D | Evonik | Copolymer (ethyl acrylate, | n/a |
| | | methyl methacrylate, | |
| | | methacrylic acid ester- | |
| | | quaternary ammonium) | |
| Resomer R203 H | Evonik | poly(D,L-lactide, acid | 26680-10-4 |
| | | terminated) | |
| Resomer R202 S | Evonik | poly(D,L-lactide), ester | 202832-99-3 |
| | | terminated | |
| PVA | | poly(viny lacetate) | 9003-20-7 |
| PCL | | poly(caprolactone) | 24980-41-4 |
| cellulose acetat | | acetylcellulose | 9004-35-7 |
| Gelatin | | porcine skin, Type A | 9000-70-8 |
| Purified water | n/a | Resistivity 18.2 MΩ · m (25° C.) | 7732-18-5 |
| AEROSIL ® 150 | Evonik | hydrophilic fumed silica | 112 945-52-5 |
| | | | 7631-86-9 |
| Atlox ® 4913 | Croda | methyl methacrylate graft | 119724-54-8 |
| | | copolymer with polyethylene | |
| | | glycol | |
| KELZAN S | CPKelco | Xanthan gum | 11138-66-2 |
| Geropon ® T36 | Solvay | Sodium polycarboxylate | 37199-81-8 |
| Chitosan-low Mw | | Deacetylated chitin, Poly(D- | 9012-76-4 |
| | | glucosamine) Mw 50-190 kDa | |
| Chitosan-high Mw | | Deacetylated chitin, Poly(D- | 9012-76-4 |
| | | glucosamine) Mw 310-375 kDa | |
| Mowiol 10-98 | Kuraray | poly(vinyl alcohol)-fully | 9002-89-5 |
| | | hydrolyzed (>98%) | |
| Mowiol 20-98 | Kuraray | poly(vinyl alcohol)-fully | 9002-89-5 |
| | | hydrolyzed (>98%) | |
| Mowiol 56-98 | Kuraray | poly(vinyl alcohol)-fully | 9002-89-5 |
| | | hydrolyzed (>98%) | |
| Mowiol ® 8-88 | Kuraray | poly(vinyl alcohol)-partially | 9002-89-5 |
| | | hydrolyzed (<90%) | |
| Mowiol ® 18-88 | Kuraray | poly(vinyl alcohol)-partially | 9002-89-5 |
| | | hydrolyzed (<90%) | |
| Mowiol ® 40-88 | Kuraray | poly(vinyl alcohol)-partially | 9002-89-5 |
| | | hydrolyzed (<90%) | |
| Morwet ® D425 | Akzo Nobel | Naphthalene sulphonate | 9008-63-3 |
| | | formaldehyde condensate Na | |
| | | salt | |
| Formaldehyde (FA) | | Methyl aldehyde | 50-00-0 |
| Glutaraldehyde (GA) | | 1,5-Pentanedial | 111-30-8 |
| 25% in water | | | |
| Terephthalaldehyde | | Benzol-1,4-dicarbaldehyd | 623-27-8 |
| (TA) 99% | | | |

1. Encapsulated active ingredient, wherein
a) the active ingredient is selected from the group of fungicides, herbicides, insecticides, nematicides, host defense inducers,
b) the amount of active ingredient in q capsule is between 1% and 99.9% by weight of active ingredient, optionally between 20% and 95% by weight of active ingredient, optionally between 25% and 95% by weight of active ingredient, and optionally between 50% and 95% by weight of active ingredient, based on the weight of the capsule,
c) the capsule comprises one or more organic polymers.

2. Encapsulated active ingredient according to claim 1, wherein the particle size of the capsule is optionally between d50=1-200 μm (micrometer), optionally between d50=1-50 μm (micrometer).

3. Encapsulated active ingredient according to claim 1, wherein the particle size of the capsule for foliar application is optionally between d₅₀=1-20 μm (micrometer).

4. Encapsulated active ingredient according to claim 1, wherein before encapsulation the active ingredient has a particle size optionally d₅₀<50 μm, optionally d₅₀<20 μm, optionally d₅₀<10 μm, and optionally d₅₀<5 μm, and before encapsulation the active ingredient has a particle size of d₅₀>0.1 μm.

5. Encapsulated active ingredient according to claim 1, wherein the active ingredient for encapsulation is selected from the group consisting of SDH-Inhibitors, nAChR-Agonists (including neonicotinoides), chlorotica including PDS inhibitors (HRAC F1) and HPPD inhibitors (HRAC F2) and thiadiazole carboxamides/host defense inducers.

6. Encapsulated active ingredient according to claim 1, wherein the active ingredient is are selected from the group consisting of Fluopyram, Flupyradifurone, Diflufenican, Isoxaflutole, Imidacloprid and Isotianil, and optionally selected from the group consisting of Fluopyram, Isoxaflutole and Diflufenican.

7. Encapsulated active ingredient according to claim 1, wherein a shell of the encapsulated ingredient is crosslinked.

8. Encapsulated active ingredient according to claim 1, wherein the organic polymer is selected from the group of water soluble polymers and hydrogel forming homo and co polymers,
optionally from the group of acrylate copolymers, chitosan and polyvinylalcohols (PVA) either being fully hydrolysed or partially hydrolyzed polyvinylacetates, and
optionally form the group of chitosan and polyvinylalcohols (PVA) either being fully hydrolysed or partially hydrolyzed polyvinylacetates.

9. Encapsulated active ingredient according to claim 7, comprising a crosslinker selected from the group consisting of formaldehyde (FA), glutaraldehyde (GA), and terephthalaldehyde (TA).

10. Encapsulated active ingredient according to claim 1, wherein the organic polymer is selected from the group gf homo- or copolymers that are soluble in an organic solvent and allow formation of an emulsion in water,
optionally the polymers are selected from the group consisting of pure D or L lactides, lactide-co-caprolactone, lactide-co-glycolide; Polyesters, polyamides, polyacrylates, polystyrenes, polyvinyls,
optionally the polymer is selected from the group consisting of poly(lactic acid) (PLA) either free acid or ester terminated, poly(caprolactone) and poly(vinylacetate),
and optionally the polymer is PLA.

11. Encapsulated active ingredient according to claim 10, wherein the polymer is PLA the Mw of the polymer is optionally between 1 to 1000 kDa, optionally between 5 and 200 kDa, even optionally between 10 and 100 kDa and optionally between 15 and 30 kDa.

12. Encapsulated active ingredient according to claim 10, wherein the organic solvent is a water miscible organic solvent,
optionally a water miscible polar solvent,
optionally water miscible aprotic polar solvent,
optionally the organic solvent is selected from the group consisting of chloroform, dichloromethane, ethylacetate and THF (tetrahydrofurane),
and optionally the organic solvent is selected from the group consisting of chloroform and dichloromethane.

13. Encapsulated active ingredient according to claim 1, wherein the organic polymer is selected from the group consisting of homo- or copolymers that are soluble in an organic solvent, optionally the polymers are selected from the group consisting of polyvinylic, polyesters, polyurethanes, polyvinylacetates, polylactones, polyethers, polysaccarides, including polyvinyl acetates, polycaprolactone and cellulose acetates and PLA (poly lactic acid).

14. Encapsulated active ingredient according to claim 1, wherein the organic polymer is selected from waterborne polymers comprising VAE, polyacrylates, polystyrenes, polyvinylic, polycaprolactones, polyesters and polyurethanes, polysaccarides, (all as homo or copolymers)

15. Encapsulated active ingredient according claim 13, wherein the polymer is PLA the Mw of the polymer is preferably optionally between 1 to 1000 kDa, optionally between 5 and 200 kDa, and optionally between 10 and 100 kDa.

16. Encapsulated active ingredient according to claim 1, wherein the Zeta-Potential of the active ingredient becomes more positive in a pH-range of 3-10 compared to non encapsulated active ingredient.

17. Formulation with an encapsulated active ingredient according to claim 1, wherein the formulation comprises:
a) encapsulated active ingredient,
b) a liquid phase,
c) optionally one or more emulsifier/dispersant,
d) optionally one or more carriers,
e) optionally one or more surfactants,
f) optionally one or more further non-encapsulated active ingredients,
g) optionally one or more further adjuvants selected from the group of extenders, stickers, penetrants, retention promoters, colourants and dyes, stabilizers, humectants and spreaders.

18. Formulation according to claim 17, wherein the formulation comprises:
Between 0.1% and 70% by weight of active compound, between 1% and 65% by weight of active ingredient, between 5% and 60% by weight of active ingredient, and between 5% and 50% by weight of active ingredient, based on the weight of the formulation.

19. A product comprising the encapsulated active ingredient according to claim 1 or a formulation thereof for curative or preventative treatment of one or more plants, plant parts, soil or seeds against one or more pests with enhanced biological compatibility or for reduction of one or more phytotoxic effects of the active ingredient.

20. Method for curative or preventative treatment of seeds with one or more encapsulated active ingredients according to any of claim 1 or with a formulation thereof, comprising treating seed.

21. Method for curative or preventative treatment gf one or more plants, plant parts, soil or seeds with one or more encapsulated active ingredients according to any of claim 1 or with a formulation thereof, comprising treating soil.

22. Method for curative or preventative treatment of one or more plants or plant parts with one or more encapsulated active ingredients according to claim 1 or a formulation thereof, comprising a foliar application.
